(19) United States
(12) Patent Application Publication
(10) Pub. No.: US 2026/0243557 A1
(43) Pub. Date: Aug. 20, 2026

(54) SMART TEXTILES

(71) Applicant: The Florida State University Research Foundation, Inc., Tallahassee, FL (US)

(72) Inventors: Weiye Xu, Tallahassee, FL (US); Te-Yen Wu, Tallahassee, FL (US); Haolin Li, Tallahassee, FL (US); Xing-Dong Yang, Tallahassee, FL (US)

(21) Appl. No.: 19/178,119

(22) Filed: Apr. 14, 2025

Related U.S. Application Data
(60) Provisional application No. 63/633,346, filed on Apr. 12, 2024.

(51) Int. Cl. G01B 7/16; G06F 3/02

(52) U.S. Cl. CPC G01B 7/16; G06F 3/02

(57) ABSTRACT

An example system for textile sensing includes a woven smart textile substrate; a receiver coil embroidered into the woven smart textile substrate; a plurality of RLC circuits formed on the woven smart textile substrate, where the plurality of RLC circuits are coupled in parallel with the receiver coil, and where each of the RLC circuits comprises a resistor, capacitor and inductor, and wherein at least one of the resistor, capacitor, or inductor are configured as sensors; and a transmitter coil configured to read the plurality of RLC circuits.

### CROSS REFERENCE TO RELATED APPLICATIONS

This application claims the benefit of U.S. provisional patent application No. 63/633,346, filed on Apr. 12, 2024, and titled “SMART TEXTILES,” the disclosure of which is expressly incorporated herein by reference in its entirety.

### BACKGROUND

Wearable devices are electronic devices that can be worn on a person's body. Wearable devices include clothing, jewelry, and accessories that include electronic components. For example, wearable devices can include sensors, actuators, and/or processors. An example wearable device is a smartwatch.

There are benefits to improving sensors and actuators that are configured to be used as wearable devices.

### SUMMARY

Methods and systems for wearable sensors are disclosed herein.

In some aspects, implementations of the present disclosure include a system including: a woven smart textile substrate; a receiver coil embroidered into the woven smart textile substrate; a plurality of RLC circuits formed on the woven smart textile substrate, wherein the plurality of RLC circuits are coupled in parallel with the receiver coil, and wherein each of the RLC circuits includes a resistor, capacitor and inductor, and wherein at least one of the resistor, capacitor, or inductor are configured as sensors; and a transmitter coil configured to read the plurality of RLC circuits.

In some aspects, implementations of the present disclosure include a system, wherein the plurality of RLC circuits are coupled by an embroidered transmission line formed on the smart textile substrate.

In some aspects, implementations of the present disclosure include a system, wherein the embroidered transmission line includes a twisted transmission line.

In some aspects, implementations of the present disclosure include a system, wherein the plurality of RLC circuits each have a respective resonant frequency, and wherein the respective resonant frequencies of the RLC circuits are different from one another.

In some aspects, implementations of the present disclosure include a system, further including a plurality of sensors, wherein each of the plurality of RLC circuits are connected to at least one sensor of the plurality of sensors.

In some aspects, implementations of the present disclosure include a system, wherein the sensor includes a strain sensor.

In some aspects, implementations of the present disclosure include a system, wherein the sensor includes at least one of a resistive sensor, capacitive sensor, or inductive sensor.

In some aspects, implementations of the present disclosure include a system including: a woven smart textile substrate; a receiver coil embroidered into the woven smart textile substrate; a plurality of RLC circuits formed on the woven smart textile substrate, wherein the plurality of RLC circuits are coupled in parallel with the receiver coil, and wherein each of the RLC circuits includes a resistor, capacitor and inductor, and wherein at least one of the resistor, capacitor, or inductor are configured as a sensor; a transmitter coil configured to read the plurality of RLC circuits by the receiver coil; a controller operably coupled to the transmitter coil, wherein the controller includes a processor, and a memory including computer-readable instructions stored thereon, that, when executed by the processor, cause the processor to: transmit, by the transmitter coil, a plurality of frequencies; and receive, by the transmitter coil, a sensor for each sensor of each RLC circuit.

In some aspects, implementations of the present disclosure include a system, wherein the plurality of RLC circuits are coupled by an embroidered transmission line formed on the smart textile substrate.

In some aspects, implementations of the present disclosure include a system, wherein the embroidered transmission line includes a twisted transmission line.

In some aspects, implementations of the present disclosure include a system, wherein the plurality of RLC circuits each have a respective resonant frequency, and wherein the respective resonant frequencies of the RLC circuits are different from one another.

In some aspects, implementations of the present disclosure include a system, further including a plurality of sensors, wherein each of the plurality of RLC circuits are coupled to at least one sensor of the plurality of sensors.

In some aspects, implementations of the present disclosure include a system, wherein the sensor includes a strain sensor.

In some aspects, implementations of the present disclosure include a system, wherein the sensor includes at least one of a resistive sensor, capacitive sensor, or inductive sensor.

In some aspects, implementations of the present disclosure include a method of textile sensing, the method including: energizing a textile interface using a handheld reader, wherein the textile interface includes a plurality of sensors and a plurality of RLC circuits, wherein each of the plurality of RLC circuits are connected to at least one sensor of the plurality of sensors; receiving a reflection from the textile interface at the handheld reader; measuring the reflection from the textile interface; and determining, based on the reflection, a sensor value for each RLC circuit.

In some aspects, implementations of the present disclosure include a method, wherein the textile interface includes a sensor, a resonator circuit; operably coupled to the sensor, and a receiver coil operably coupled to the resonator circuit.

In some aspects, implementations of the present disclosure include a method, wherein determining the sensor value includes estimating an impedance of the textile interface.

In some aspects, implementations of the present disclosure include a method, wherein determining the sensor value includes estimating a reflection coefficient of the textile interface.

In some aspects, implementations of the present disclosure include a method, wherein the plurality of RLC circuits each have a respective resonant frequency, and wherein the handheld reader is configured to transmit each respective resonant frequency of the plurality of RLC circuits to read each sensor of the plurality of sensors.

In some aspects, implementations of the present disclosure include a method, wherein the sensor values include at least one detection of a button press.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates an example system including a textile interface and reader, according to implementations of the present disclosure.

FIG. 2A illustrates an example reader and textile interface, according to implementations of the present disclosure.

FIG. 2B illustrates an example circuit schematic illustrating a textile interface and reader, according to implementations of the present disclosure.

FIG. 2C illustrates an example circuit schematic illustrating a textile interface and reader, according to implementations of the present disclosure.

FIG. 3 illustrates an example method of reading a textile interface, according to implementations of the present disclosure.

FIG. 4 is an example computing device.

FIG. 5A illustrates an example schematic of a smart shirt, according to a study of an implementation of the present disclosure.

FIG. 5B illustrates example results of inductive, resistive, and capacitive sensing, according to a study of an implementation of the present disclosure.

FIG. 6A illustrates an example circuit schematic used in the study of an implementation of the present disclosure.

FIG. 6B illustrates an example circuit used in the study of an implementation of the present disclosure.

FIG. 6C illustrates an example circuit embedded in a shirt, according to an implementation of the present disclosure.

FIG. 7 illustrates ground truth results and predicted results, according to a study of an example implementation of the present disclosure.

FIG. 8 illustrates capacitance, inductance, and resistance of twisted transmission lines shown by length, according to a study of an example implementation of the present disclosure.

FIG. 9 illustrates dimensions, inductance, and coupling factors of coil designs, according to implementations of the present disclosure.

FIG. 10 illustrates capacitance and inductance of transmission line designs, according to implementations of the present disclosure.

FIG. 11 illustrates an absolute impedance spectrum and resonance frequencies for a model validation of an example implementation of the present disclosure.

FIG. 12A illustrates accuracy of coupling factor estimation across frequencies ranging from 1 MHz to 30 MHz, according to an example implementation of the present disclosure.

FIG. 12B illustrates accuracy of estimating single capacitive sensor value across frequencies ranging from 1 MHz to 25 MHz, considering four different ranges of transmission line lengths, according to an example implementation of the present disclosure.

FIG. 12C illustrates accuracy of estimating single resistive sensor value across frequencies ranging from 1 MHz to 25 MHz, considering four different ranges of transmission line lengths, according to an example implementation of the present disclosure.

FIG. 13A illustrates example accuracies of estimating capacitive/inductive sensor values across frequencies ranging from 5 MHz to 20 MHz, according to an example implementation of the present disclosure.

FIG. 13B illustrates example accuracies of estimating resistive sensor values across frequencies ranging from 5 MHz to 20 MHz, according to an example implementation of the present disclosure.

FIG. 14A illustrates an example resistive button array including 3 pressure-sensitive buttons, where each button includes two pieces of conductive fabric strip (width=6 mm).

FIG. 14B illustrates an example inductive object detector including a 10-turns coil (25 mm by 40 mm) with an inductance of 5.4 uH.

FIG. 14C illustrates an example capacitive pressure sensor constructed by two pieces of conductive fabric of about 17 mm by 34 mm sandwiching two 10 mm×10 mm×2 mm square pieces of resistive rubber.

FIG. 14D illustrates an example a capacitive bend sensor constructed by two pieces of conductive fabric of about 10 mm by 25 mm sandwiching a piece of resistive foam with a thickness of about 1 mm.

FIG. 15 illustrates a glove prototype with bend sensors on the thumb, index, and middle fingers to capture finger gestures.

FIG. 16A an example confusion matrix for a resistive button array, according to a study of an example implementation of the present disclosure.

FIG. 16B an example confusion matrix for a capacitive pressure sensor, according to a study of an example implementation of the present disclosure.

FIG. 16C an example confusion matrix for a capacitive pressure sensor, according to a study of an example implementation of the present disclosure.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for sensors embedded in textiles, it will become evident to those skilled in the art that the implementations are not limited thereto, but are applicable for any other type of sensing using embedded sensors.

Described herein are systems and methods for textile interfaces. As used herein, a “textile interface” refers to sensors and/or actuators that can be integrated onto or into textiles (e.g., various fabrics). For example, textile interfaces can be used to implement user interfaces into textiles, and/or enable the textile to sense its environment.

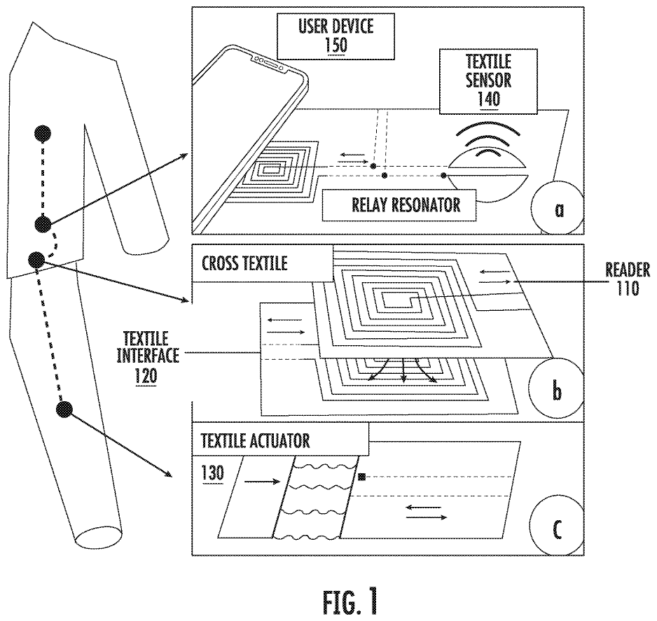

With reference to FIG. 1, an example system is shown including a textile interface. The example system of FIG. 1 can be used to provide textile sensing.

The example system can include a reader 110. The reader 110 can be configured to transmit a signal (e.g., a radiofrequency signal) with known characteristics. The reader 110 can further be configured to receive and analyze signals. The reader 110 can therefore transmit a known signal and receive the reflection of the known signal. The reader can include one or more antennas (e.g., coiled antennas) that are configured to transmit the known signal and/or receive the reflection of the known signal.

The example system can further include a textile interface 120. The textile interface 120 can include one or more antennas (e.g., coiled antennas) that are configured to reflect the signal transmitted by the reader 110. By characterizing the properties of the reflected signal, the reader 110 can determine the characteristics of the textile interface (e.g., the impedance of the textile interface.

Still with reference to FIG. 1, the textile interface 120 can optionally include a textile actuator 130. Textile actuators can include components that use energy to act on the environment (e.g., by heating/cooling, producing mechanical work, or outputting signals). As non-limiting examples, the textile actuator 130 can include vibrating motors, heaters, and/or speakers that can be formed in/on textiles. The textile interface 120 can optionally be configured to receive electrical power transmitted from the reader 110.

As shown in FIG. 1, the present disclosure also contemplates that the reader 110 can be operable with a user device 150 (e.g., a mobile computing device) to read a textile sensor 140.

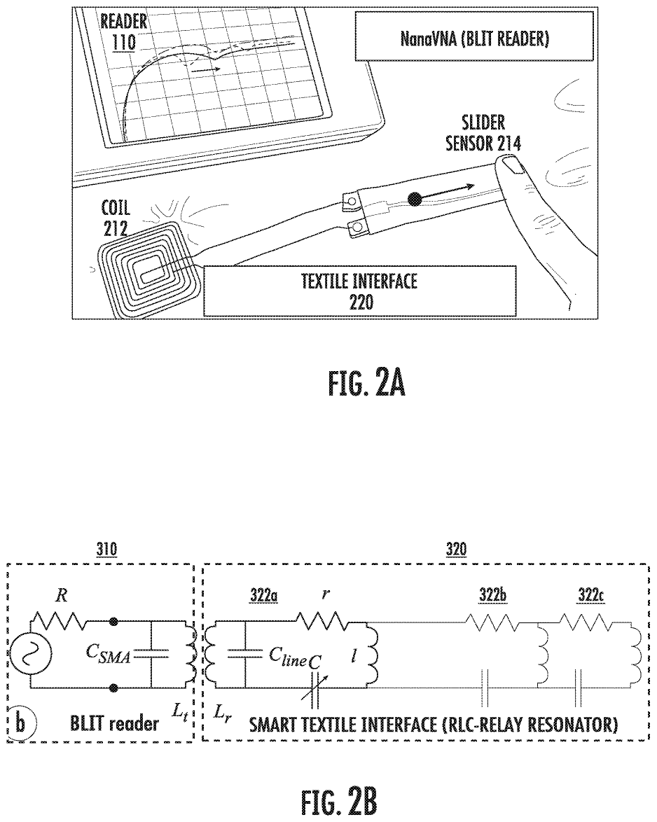

FIG. 2A illustrates an example textile interface 220 including a coil 212 and slider sensor 214. A reader 110 positioned adjacent to the textile interface 220 displays the response of the textile interface 220.

FIG. 2B illustrates an example circuit schematic of a reader 310 and an example circuit schematic of a textile interface 320 that can be used to implement the reader 110 and textile interfaces 120, 220 shown in FIGS. 1 and 2A, respectively. The reader 310 can be modeled as a capacitor, resistor, antenna, and signal generator as shown in FIG. 2B. The textile interface 320 can be modeled as an antenna (e.g., a receiver coil) and at least one RLC circuit 322a. The RLC circuit 322a can be tuned to resonate at different frequencies by changing the resistance (R), capacitance (C), and/or the inductance (L) of the RLC circuit. The RLC circuit can allow certain frequencies to resonate in the circuit (e.g., frequencies transmitted by the reader). When the received signal is a frequency that resonates with the RLC circuit, electromagnetic coupling between the reader 310 and textile interface 320 can be used by the reader 310 to acquire data from the textile interface 320 and/or transmit power to the textile interface 320.

As shown in FIG. 2B, any number of RLC circuits 322a, 322b, 322c can be incorporated into the textile interface 320. Optionally the RLC circuits 322a, 322b, 322c can be coupled in parallel. The resonant frequencies of the RLC circuits 322a, 322b, 322c can be the same or different from one another, allowing different RLC circuits to electromagnetically couple to the reader 310 at different frequencies. For example, the reader can optionally transmit at a first frequency to energize the first RLC circuit 322a and deliver power to a device coupled to the first RLC circuit 322a. The reader 310 can optionally then transmit at a second frequency to electromagnetically couple to the second RLC circuit 322b and receive data from a sensor coupled to the second RLC circuit 322b. The reader 310 can optionally then transmit at a third frequency to electromagnetically couple to the third RLC circuit 322c.

It should be understood that the RLC circuits 322a, 322b, 322c shown in FIG. 2B are non-limiting examples of circuits that can be used to implement resonators. Implementations off the present disclosure can include any type of resonator circuit, and can include any number or resonator circuits, so that any number of actuators and/or sensors can be part of the textile interface 320.

Non-limiting examples of sensors that can be used in implementations of the present disclosure include sensors with resistive, capacitive and inductive components (i.e., resistive sensors, capacitive sensors, and inductive sensors, respectively). Resistive, capacitive, or inductive sensors can change their resistance, capacitance, and inductances, respectively in response to environmental conditions. When a resistive, capacitive, or inductive sensor is coupled to an RLC resonator, changes in the resistance, capacitance or inductance of the sensor can affect the RLC resonator's response, and the changed response can be detected by the reader 310. Thus implementations of the present disclosure can allow the reader to read sensors that are part of the textile interface 320 without the textile interface 320 requiring a power supply and/or processor.

FIG. 2C illustrates another example implementation of the present disclosure, showing details of two RLC circuits 322a, 322b. the first RLC circuit 322a is configured with an inductive sensor 323a. The second RLC circuit 322b is configured with a resistive sensor 323b. Optionally, additional RLC circuits (e.g., a third RLC circuit with a capacitive sensor) could be added to the configuration shown in FIG. 2C.

Non-limiting examples of sensors that can be part of the textile interface 320 include slider sensors, capacitive touch sensors, pressure sensors, bending sensors, and moisture sensors. Optionally, the sensors can be fabricated using conductive fabric electrodes and/or embroidered conductive threads.

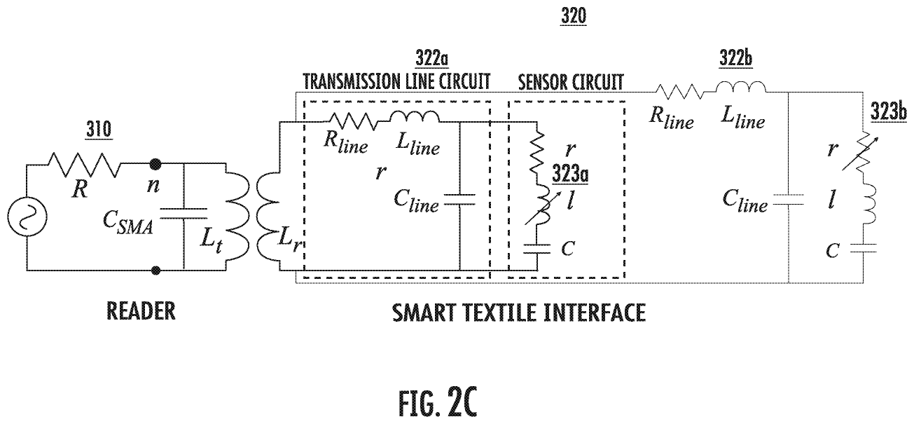

With reference to FIG. 3, implementations of the present disclosure include methods of reading sensors in a textile interface using a reader (e.g., using the reader 110 shown in FIG. 1 to read the textile interface 120 shown in FIG. 1.

At step 350, the method includes energizing the textile interface using a handheld reader.

At step 360, the method includes receiving a reflection from the textile interface at the handheld reader.

At step 370, the method includes measuring the reflection from the textile interface.

At step 380 the method includes determining, based on the reflection, a sensor value. Optionally, the sensor value can be determined by estimating an impedance (resistance, capacitance, and/or inductance) of the textile interface.

In some implementations of the present disclosure, the method can be repeated any number of times to read multiple sensors operably coupled to any number of resonators or resonator circuits. The method can optionally include “sweeping” the reader between different frequencies, so that different resonators in a system resonate as the reader sweeps between frequencies. This allows the reader to read any number of sensors in sequence. Implementations of the present disclosure can therefore be used to read any number of sensors in systems including any number of sensors. As a non-limiting example, a wearable device or wearable system can include multiple sensors to measure strain at different points in a garment, and can also include multiple sensors to implement a user interface. By sweeping between different frequences (e.g., the resonant frequencies of each of the sensors in the system) the reader in the system can obtain information from each sensor in the system. This allows for wearable devices and systems with multiple sensors and interfaces, where some or all of the sensors and interfaces are not powered, allowing for lightweight and/or small wearable devices. The example herein provides additional description of methods for reading the textile interfaces with the reader 310.

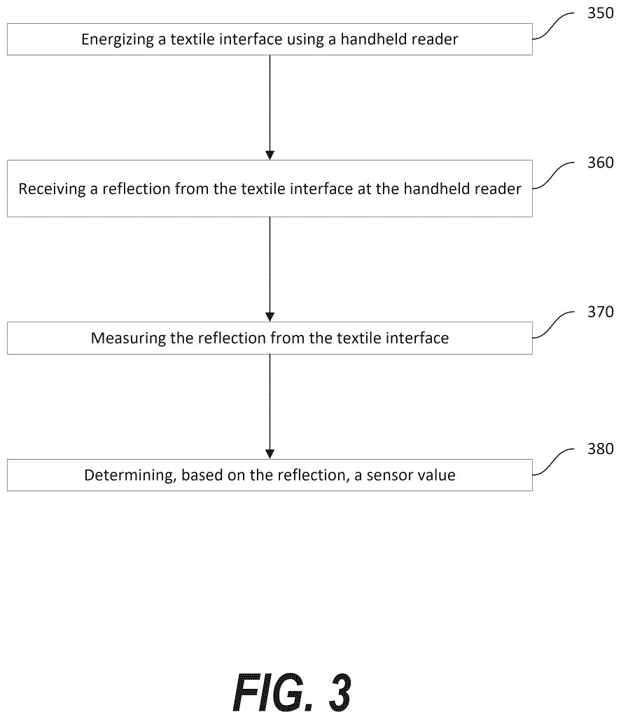

It should be appreciated that the logical operations described herein with respect to the various figures may be implemented (1) as a sequence of computer implemented acts or program modules (i.e., software) running on a computing device (e.g., the computing device described in FIG. 4), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 4, an example computing device 400 upon which the methods described herein may be implemented is illustrated. It should be understood that the example computing device 400 is only one example of a suitable computing environment upon which the methods described herein may be implemented. Optionally, the computing device 400 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 400 typically includes at least one processing unit 406 and system memory 404. Depending on the exact configuration and type of computing device, system memory 404 may be volatile (such as random access memory (RAM)), non-volatile (such as read-only memory (ROM), flash memory, etc.), or some combination of the two. This most basic configuration is illustrated in FIG. 4 by dashed line 402. The processing unit 406 may be a standard programmable processor that performs arithmetic and logic operations necessary for operation of the computing device 400. The computing device 400 may also include a bus or other communication mechanism for communicating information among various components of the computing device 400.

Computing device 400 may have additional features/functionality. For example, computing device 400 may include additional storage such as removable storage 408 and non-removable storage 410 including, but not limited to, magnetic or optical disks or tapes. Computing device 400 may also contain network connection(s) 416 that allow the device to communicate with other devices. Computing device 400 may also have input device(s) 414 such as a keyboard, mouse, touch screen, etc. Output device(s) 412 such as a display, speakers, printer, etc. may also be included. The additional devices may be connected to the bus in order to facilitate communication of data among the components of the computing device 400. All these devices are well known in the art and need not be discussed at length here.

The processing unit 406 may be configured to execute program code encoded in tangible, computer-readable media. Tangible, computer-readable media refers to any media that is capable of providing data that causes the computing device 400 (i.e., a machine) to operate in a particular fashion. Various computer-readable media may be utilized to provide instructions to the processing unit 406 for execution. Example tangible, computer-readable media may include, but is not limited to, volatile media, non-volatile media, removable media and non-removable media implemented in any method or technology for storage of information such as computer readable instructions, data structures, program modules or other data. System memory 404, removable storage 408, and non-removable storage 410 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 406 may execute program code stored in the system memory 404. For example, the bus may carry data to the system memory 404, from which the processing unit 406 receives and executes instructions. The data received by the system memory 404 may optionally be stored on the removable storage 408 or the non-removable storage 410 before or after execution by the processing unit 406.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### Examples

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

An example implementation of the present disclosure was designed and tested in a study. The example implementation studied illustrates improvements for integrating user interfaces into wearable items such as garments, gloves, and bags, offering an alternative to traditional devices like touchscreens. In particular, implementations of the present disclosure can overcome existing problems implementing smart textiles to overcome challenges in manufacturability [15, 47, 79], usability [20, 62, 70] and environmental sustainability [52, 65, 66], primarily due to the embedment of rigid electronic components such as batteries and circuits into textile interfaces. Existing components can be uncomfortable, inflexible, reduce the usability of the wearable items, and contribute to electronic waste when textile products become obsolete.

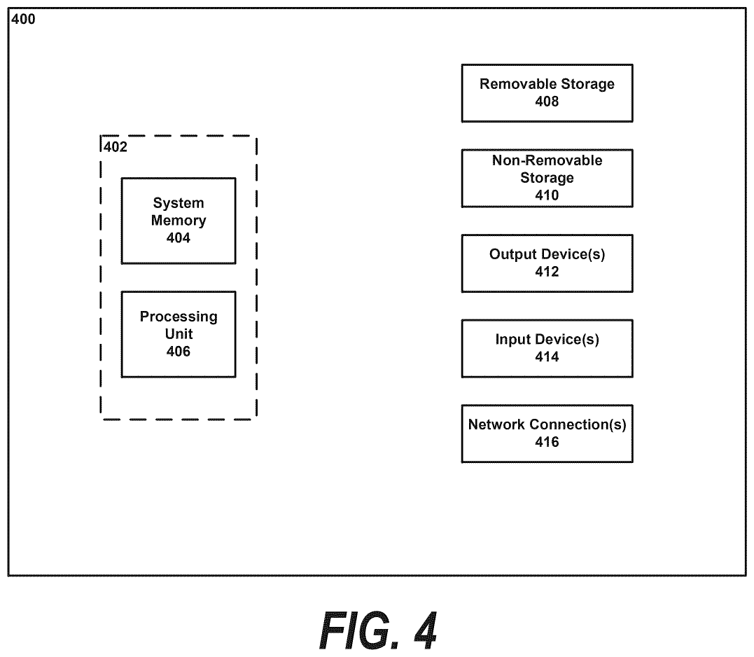

The example implementation herein can overcome these and other problems with existing systems and methods. The example implementation can use a resonator-based technique involving N-parallel series RLC (resistor-inductor-capacitor) circuits on the receiver coil as shown in FIG. 5A. Unlike the approaches described above, the example implementation can support at least three different types of sensors commonly used in smart garment applications, including resistive, capacitive, and inductive sensors. Additionally, the example implementation takes into account the influence of the transmission lines and coil misalignment, ensuring more accurate and robust sensor readings. Furthermore, the technique allows for the concurrent operation of up to three sensors of the same or different types. When a user interacts with the interface, such as pressing a capacitive sensor, the interaction causes a change in the system's impedance as shown in FIG. 5B, which can then be wirelessly measured and detected by an external reader.

The study herein included designing and fabricating a proof-of-concept prototype including a smart textile interface, which includes sensors and a receiver coil sewed on a textile substrate, and a reader comprising a transmitter coil and a vector network analyzer for measuring impedance spectrum of the smart textile interface. The specific design of smart textile interfaces can be customized to support a range of resistive, capacitive, or inductive sensor, depending on the specification of sensors and the number of sensors implemented in the interface. When the transmitter coil is aligned with the receiver coil on the interface, the reader wirelessly measures the impedance spectrum of the interface. The example implementation can use an algorithm to analyze the measured impedance spectrum for sensor signal estimation. This algorithm can include a mathematical model derived from the equivalent circuit of the system, accounting for real-world factors such as transmission line effects and coil misalignment, both of which can affect the measured impedance. To enhance the accuracy and efficiency of sensor value estimation, this algorithm incorporates one additional known LC circuit within the interface. The example simulation-based experiments showed that the example system can reliably capture the sensor signals with an average accuracy over 90%. Additionally, the study included a user study to validate the system's performance in real world conditions. The results demonstrated that the system robustly captured sensor signals generated by user interactions with an augmented shirt, and achieved an overall accuracy of 93% in classifying user interactions.

The example implementation included an approach that uses the structure of N-parallel series RLC circuits to address the limitation of resonance-based sensors in battery-free, IC-less and wireless smart textile interfaces; and mathematical model and algorithm that enable the sensing system to accurately estimate sensor values from measured impedance spectrum. The study includes experimental results demonstrating the effectiveness of the proposed approach.

The example includes a smart textile interface that operates without the inclusion of batteries and ICs within textiles, while retaining the ability to support various types of textile sensors. The example implementation is based on resonant sensors, which utilize the characteristics of resonant circuits to wirelessly reflect the sensor signals to an external reader, eliminating the need for embedding batteries and ICs into textiles. This section discusses the operating principle, and provides further understanding in the electrical behavior of this interface.

Implementations of the present disclosure improve conventional sensor circuits. For example, to support more common sensor types, including capacitive, resistive, and inductive, the example implementation replaced the capacitor (C) in the typical LC circuit by a series RLC resonant circuit, as shown in FIG. 2C. This resonant circuit, referred to herein as a sensor circuit, can include a resistor, inductor, and capacitor, designed to operate within a specific frequency range. Different sensors can be supported by replacing the corresponding components. For example, replacing the inductor with a coil forms an inductive sensor for detecting metallic objects. To enable concurrent operation of multiple sensors, the example implementation connected multiple sensor circuits in parallel, each designed to operate at distinct frequency ranges. This allows the example smart textile interface to detect inputs from multiple sensors with minimal passive components.

During operation, the oscillating magnetic field produced by the reader's transmitter coil induce a current within the smart textile interface through near-field magnetic coupling with the receiver coil. User interaction with the sensor induces a change in the value of the corresponding component within the RLC resonant circuit (e.g., inductance variations due to metallic objects), causing a shift in the impedance spectrum of the smart textile interface. Consequently, this affects the current circulating within the transmitter coil, ultimately resulting in changes in the impedance spectrum within the reader circuit. The example system measured these changes and used an algorithm to extract sensor values for the detection of user input.

Numerous factors actually influence the impedance spectrum of the smart textile interface, complicating wireless sensor readings. These factors include the design of the sensor circuits, the parasitic capacitance and inductance of transmission lines, and the misalignment between the transmitter and receiver coils. To address these challenges, the study included a mode of the circuits within the smart textile interface and developed corresponding solutions to them.

The equivalent circuit model is a simplified representation of the system's electrical behavior. Different versions exist, balancing accuracy and simplicity based on the level of detail needed. For example, in some models [24, 25], transmission line behavior could be simplified to just parasitic capacitance and resistance, neglecting the effects of parasitic inductance. For the example system, a goal was to develop an equivalent circuit model that is accurate enough to capture key behaviors and simple enough for the analysis of the example system. The study designed the model as shown in FIG. 2C [24]. Using this model, the following equations describe the impedance of the entire system, based on the literature on wireless power transfer systems [61]:

$$Z ( f ) = \frac{1}{\frac{1}{( 2 π {fL}_{t} ) j - \frac{{{Z}_{M} ( f )}^{2}}{{Z}_{s} ( f )}} + 2 π {fC}_{S M A} j} \qquad ( 1 )$$

$${Z}_{M} ( f ) = ( 2 π f ) k \sqrt{( {L}_{t} {L}_{r} )} j \qquad ( 2 )$$

$${Z}_{S} ( f ) = \frac{1}{{\sum }_{1}^{n} \frac{1}{{Z}_{i} ( f )}} + ( 2 π {fL}_{r} ) j \qquad ( 3 )$$

$${Z}_{i} ( f ) = \frac{1}{\frac{1}{( 2 π {fl}_{i} - \frac{1}{2 π {fc}_{i}} ) j + {r}_{i}} + 2 π {fC}_{{line}_{i}} j} + 2 π {fL}_{line} j + {R}_{{line}_{i}} \qquad ( 4 )$$

where Z represents the total measured impedance, f is the operating frequency, Z_M is the impedance of mutual inductance, k is the coupling factor between the transmitting and receiving coils, Z_S is the impedance of the smart textile interface, Z_i is the impedance of the i\hat{ }th sensor circuit connected through a transmission line, n is the number of resonant circuits embedded in the interface, and j is the imaginary unit.

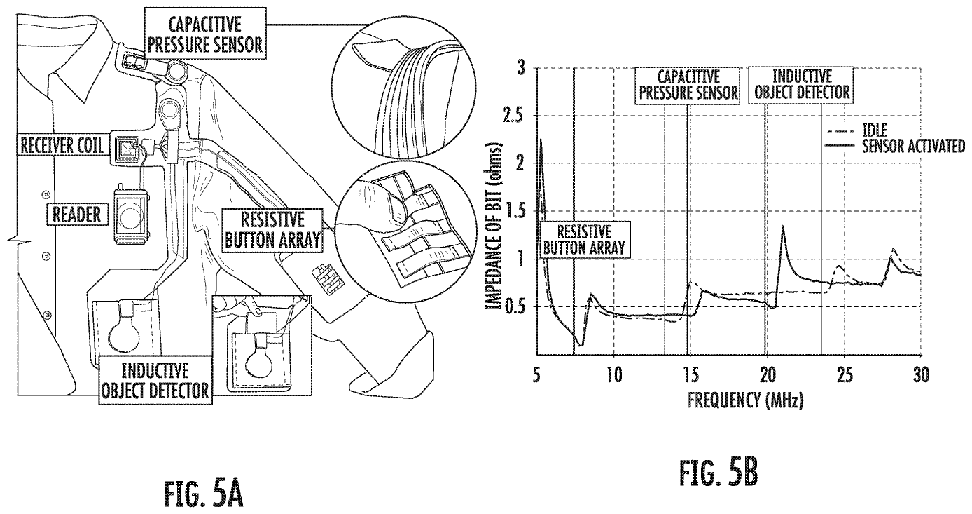

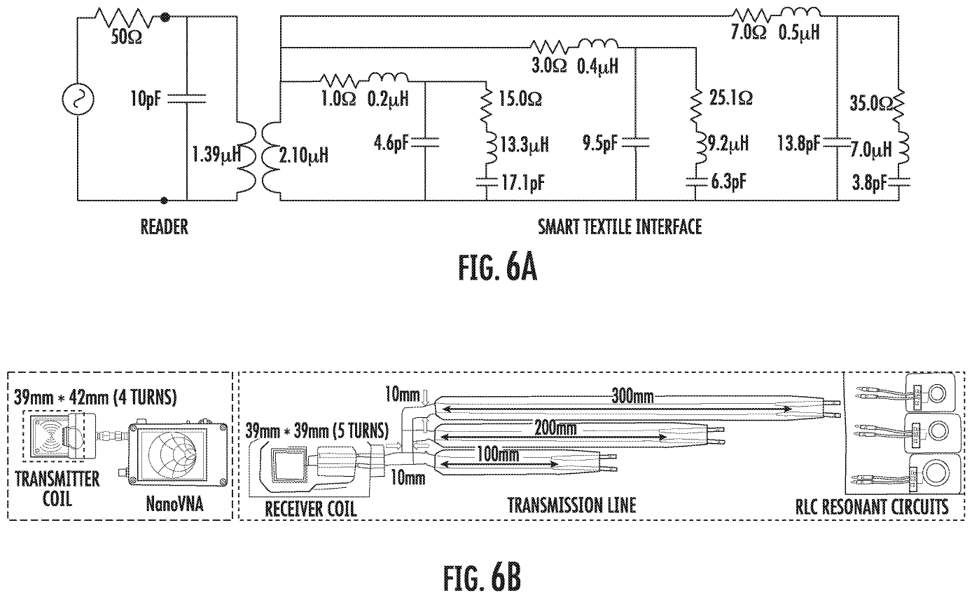

To validate the effectiveness of the circuit model, the study implemented a hardware prototype and compared the impedance spectrum generated by the model with the actual spectrum from the prototype. The prototype, including of a reader made from a VNA and a smart textile interface with three sensor circuits, as shown in FIG. 6B, was affixed to the back of a collared shirt worn by a 23-year-old male volunteer as shown in FIG. 6C. The circuit diagram is shown in FIG. 6A. During data collection, the reader measured the S11 reflection coefficient from 1 MHz to 40 MHz to retrieve the ground-truth impedance spectrum. S11 quantifies the portion of a wave reflected by impedance discontinuities and is easier to measure accurately with the reader than the impedance spectrum itself. Similar to impedance, S11 also has real and imaginary components, which can be measured separately using the VNA. On the other hand, with the parameters described in FIG. 6A, the study calculated an estimation of the impedance spectrum using the model (Eq. 1-4). Then, the study derived the S11 values using the following formula:

$$S 11 = \frac{Z - 50}{Z + 50} \qquad ( 5 )$$

where 50Ω is the standardized internal impedance of NanoVNA. Finally, the study compared the estimated S11 values with the measured ground-truth S11 values. FIG. 7 illustrates the comparison. Overall, the estimation aligns relatively well with the ground truth values (R\hat{ }2=0.96), despite small discrepancies in the frequency range higher 30 MHz. This may be attributed to the capacitive coupling between two coils. To mitigate this effect, the study restricted the operating frequency of the system within the range of 1 MHz and 30 MHz.

From the validated circuit model, the study derived several key insights. First, each resonant circuit incorporates only one type of sensor-resistive, capacitive, or inductive—while keeping other components fixed, shown by Eq. 4. This reduces unknown variables, increasing model accuracy and solving speed when the operating frequency is within the circuit's resonant range. Second, the coupling factor (k), as shown in Eq. 1 and Eq. 2, is crucial in determining how user-induced impedance changes are observed in the reader's impedance spectrum. A higher k leads to more pronounced impedance changes, but consistency in k is necessary to avoid inconsistencies in measured impedance spectrum. k is influenced by coil design and alignment, with misalignment being inevitable in real-world conditions. Thus, transmitter and receiver coils should be designed for a high coupling factor and tolerance to misalignment, even when placed in a small pocket. Additionally, high coil inductance increases total impedance at high frequencies, reducing sensor-induced impedance changes, so a trade-off must be made during coil design. Finally, Eq. 4 suggests that transmission lines should be designed to minimize variation in capacitance (C line) and inductance (L_line) and to keep C line low. High variation complicates impedance spectrum changes, reducing reading accuracy, while high C line can short-circuit high frequencies, diminishing sensor circuit changes.

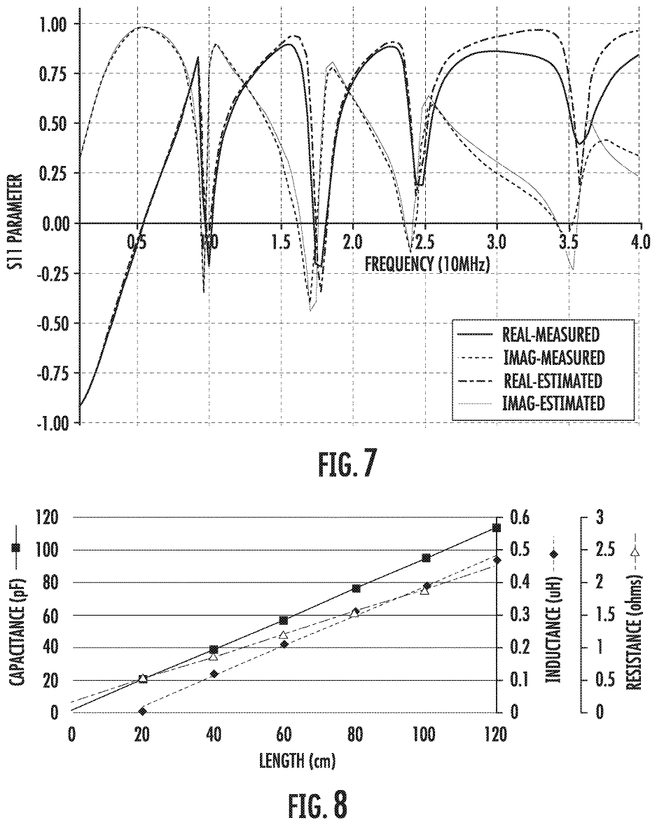

To ensure consistent performance of sensor value estimation in the system, the study tested various transmitter and receiver coil designs to maintain a high and consistent coupling factor (k) in both aligned and misaligned conditions. The study selected a rectangular coil design to maximize coverage areas. The study explored 9 combinations of 3 transmitter and 3 receiver coil types, with transmitter coils fabricated on Flexible Printed Circuit Boards (similar to phone NFC coils), and receiver coils fabricated on textile substrates via method same as section 6.1. The study tested the coupling factor (k) by aligning each coil pair at three positions: perfect alignment (0 mm), slight misalignment (5 mm), and moderate misalignment (10 mm). Using a two-port VNA connecting to transmitter and receiver coil, the study measured mutual inductance to determine the coupling factor [36]. The results and coil design parameters are presented in FIG. 9

The results indicated that larger transmitter coils produced higher k values when aligned but performed poorly under misalignment. The study eliminated coil designs with k values below 0.2 under misalignment. Among the remaining coil designs, the study selected the transmitter coil with the width of 10 mm, and the receiver coil with the width of 40 mm for the subsequent studies and implementation. This choice was made because they maintained consistent k higher than 0.25 across different conditions. Additionally, their inductances were low, resulting in smaller reactance in the high frequency range, maximizing the prominence of impedance changes caused by the sensor circuits. Furthermore, the smaller transmitter coil is better suited for integration into compact devices, such as smartwatches.

Another design factor in the smart textile interface is the transmission line design. The study goals were twofold: minimize variation in parasitic capacitance and inductance, especially in wearable contexts with potential deformation, and reduce parasitic capacitance to free up high-frequency spectrum for more sensor circuits. The study explored four transmission line designs: 10 mm-spaced, 5 mm spaced, 2.5 mm-spaced parallel lines, and twisted lines. These were chosen based on trade-offs between spacing and parasitic effects. Wider spacing, like the 10 mm design, reduced capacitance but increased inductance and susceptibility to external interference from the human body and textile deformation. Narrower spacing, such as the twisted design, reduced external interference but increased parasitic capacitance. To test how parasitic capacitance and inductance were affected by external influences, the study initially measured these values using an LCR meter [3], then subjected the lines to three conditions: 90-degree bending (simulating typical deformations), 180-degree folding (extreme deformations), and contact with the human body. After each manipulation, the study remeasured capacitance and inductance.

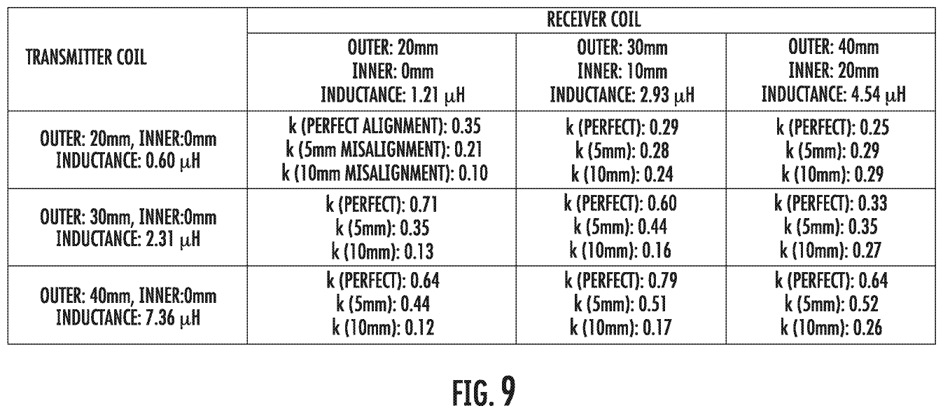

Results are shown in FIG. 10. The study found that parallel transmission lines were significantly affected by the human body, causing notable capacitance changes. Extreme deformation also led to their inductance variations of up to 12%, 10%, and 5% for 10 mm, 5 mm, and 2.5 mm-spaced designs, respectively. In contrast, the twisted transmission line design maintained consistent inductance and capacitance, despite having a higher capacitance (58 pF). The example implementation selected by the study included a twisted design, although it should be understood that other designs, like the 2.5 mm-spaced parallel design, are viable. For example, the 2.5 mm-spaced parallel design has inductance variations that were smaller and capacitance variations can be potentially addressed by the sensor value estimation algorithm.

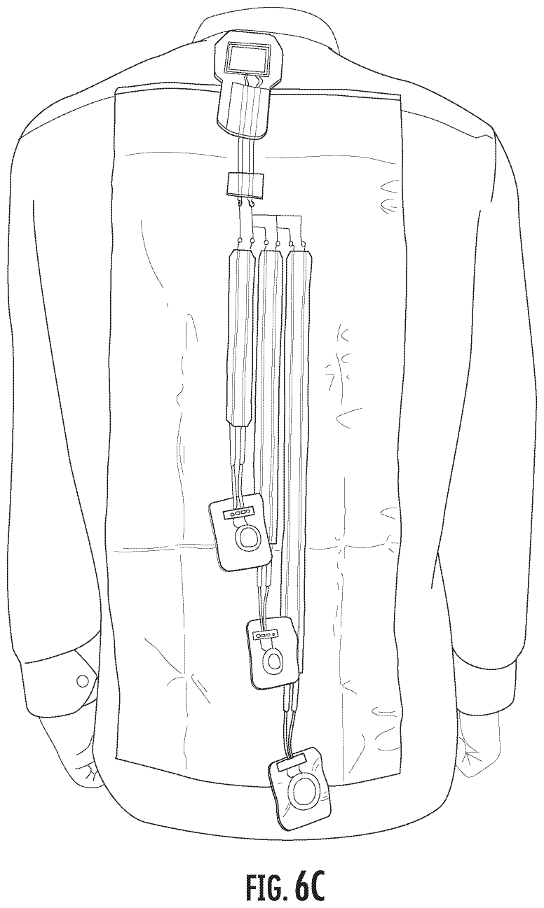

To inform the following design and implementation of smart textile interfaces, the study additionally conducted an experiment to measure the resistance, capacitance, and inductance of twisted transmission lines ranging from 200 mm to 1200 mm on the human body, with results shown in FIG. 8. The properties showed a strong correlation with length (R²=0.99). For the longest line (1200 mm), the capacitance was 113.5 pF, which could limit impedance changes in the high-frequency range. However, the study confirmed that the low frequency range is sufficient to support up to three sensor circuits.

Once the coil and transmission line designs for smart textile interfaces were determined, another challenge was the development of an algorithm to extract sensor values from the measured S11 spectrum. An optimization algorithm can estimate unknown sensor values by iterating through all possible parameters to find the best fit to the mathematical impedance model, this approach was not used for two reasons. First, although many variables such as Lₜ, Lᵣ, C_{SMA}, and other preset component values in sensor circuits can be assumed known in the fabrication process, the mathematical model still involved too many unknown parameters, such as k, Cₗᵢₙₑ and each sensor value. Thus, directly using optimization algorithms often leads to convergence to local minima and is unstable in finding the true global solution. Second, the mobile impedance reader was typically limited in capturing a high-resolution, high-precision impedance spectrum, which constrained both the quality and quantity of data points available for optimization algorithms. This limitation could cause the fitting process to fail, as the optimization might converge to inaccurate solutions due to insufficient detailed information. These limitations lead to alternative approaches to reliably extract sensor values from the measured impedance spectrum.

To overcome this challenge, the study used impedance at the resonant frequency of each sensor circuit to predetermine some factors in steps. This is because at resonance, the sensor circuit's impedance is near zero if the resistance is low. This creates a short circuit in the smart textile interface, simplifying the circuit model and allowing the equations to be approximated as follows:

$$\vert Z ( f ) \vert = \vert \frac{1}{\frac{1}{( 2 π {fL}_{t} ) j - \frac{{( ( 2 π f ) k \sqrt{( {L}_{t} {L}_{r} )} )}^{2}}{2 πf ( {L}_{{line}_{i}} + {L}_{r} ) j}} + 2 π {fC}_{SMA} j} \vert \qquad ( 6 )$$

where i indicates the ith sensor circuit in which the resonance occurs and Lₜ, Lᵣ, C_{SMA}, Lₗᵢₙₑ and Rₗᵢₙₑ, are known during fabrication process (see Appendix A for approximation details).

By leveraging this idea, the study additionally incorporated a reference circuit with known LC components into the smart textile interface. Since the values of the LC components in the reference circuit were predetermined, the study can directly obtain its resonant frequency and use the resonant frequency as a starting point to navigate the challenges in estimating sensor values. As a result, the algorithm can be divided into the following three steps.

In light of Eq 6, the study can calculate the coupling factor directly at the resonant frequency of the reference LC circuit, without needing to estimate sensor values and the capacitance of each transmission line (Cₗᵢₙₑ). However, to do this, the study must first obtain the impedance at that resonant frequency. Due to the limited number of data points measured from the reader, the S11 value at the exact resonant frequency may not be directly available. To address this, the study used a linear interpolation technique to estimate the S11 value at the desired frequency. The system then converted the S11 value to the impedance at the resonant frequency, allowing the coupling factor to be calculated using Eq. 6.

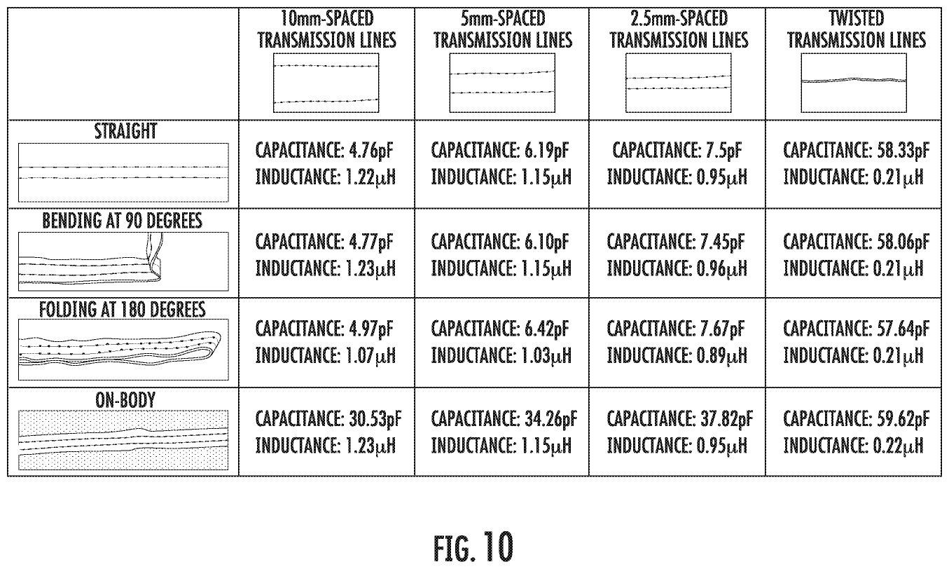

Once the coupling factor (k) was estimated, the study's second step was to identify the resonant frequency of each sensor circuit and derive the corresponding capacitive or inductive sensor values. This step was challenging, as the lowest peaks in the absolute impedance spectrum do not correspond to the actual resonant frequencies of these sensor circuits, as illustrated by the red lines in FIG. 11. The reactive components, including the inductance of the receiver and transmitter coils and the impedance of the transmission lines, interact with sensor circuits significantly, causing complex shifts in impedance spectrum. To accurately find the resonant frequency of each RLC circuit, the study applied Eq. 6 in reverse.

Specifically, given the coupling factor (k) is known, Eq. 6 becomes an equation with a single variable, the frequency (f). Thus, the algorithm can plot Eq. 6 across the frequency spectrum for each sensor circuit and search for intersections with the impedance spectrum that was converted and interpolated from the measured S11 spectrum, (as shown by the green lines in FIG. 11). The frequencies at these intersections are potential resonant frequencies for the sensor circuits, as they satisfy Eq. 6. To determine which frequency is the resonant frequency of each sensor circuit, the algorithm seeks for the points where the impedance trend increases. This is because this increasing trend indicates that the system is approaching to another resonance due to the sensor circuit. Finally, the algorithm select the frequency closest to the last estimated resonant frequency. Once the resonant frequency is determined, the algorithm can easily derive the capacitive or inductive sensor value in each sensor circuit using the formula of the resonant frequency of an RLC circuit [41]:

$$f = \frac{1}{2 π \sqrt{{l}_{i} {c}_{i}}} \qquad ( 7 )$$

where one of lᵢ and cᵢ is assumed to be known during the fabrication process and the other is the sensor value.

After determining the capacitive and inductive sensor values in each sensor circuit, the final step was to estimate resistive sensor values. Unlike the previous steps, there were no alternative methods or shortcuts available to estimate the resistive sensor values. The study solved the capacitance of each transmission line (Cₗᵢₙₑ_{ᵢ}) first before proceeding with the resistive value approximation.

The strategy for estimating Cₗᵢₙₑ_{ᵢ} was adjusting each Cₗᵢₙₑ_{ᵢ} until the lowest peaks' frequencies from the predicted S 11 spectrum align with those from measure S 11 spectrum. This strategy was designed due to the insight that the value of Cₗᵢₙₑ_{ᵢ} can significantly influence the peak positions in the S 11 or impedance spectrum, as these peaks occur when all reactive components in the circuits of the smart textile interface cancel each other out. However, it is important to note that this estimation may be not accurate enough due to the limited resolution of the reader's measurements.

Once the transmission line capacitance was roughly estimated, the algorithm shifted to approximate resistive sensor values. To achieve this, the study employed a regression fit optimization algorithm (i.e. Trust Region Reflective algorithm in the implementation) to search for the best-fitting resistive sensor values that would allow the predicted S11 spectrum to closely align with the measured S11 spectrum. The initial guess for this optimization algorithm was based on the last estimated resistive values. Simultaneously, the algorithm refined the transmission line capacitance as well, to further improve the alignment between the measured spectrum and the estimated spectrum. This approach allowed the algorithm to approximate the resistive sensor values with reasonable accuracy. Note that this accuracy was primarily dependent on the precision and resolution of S11 or impedance spectrum. Currently, the study focused on the S 11 spectrum because it was directly measured by the reader. Converting the S 11 spectrum to the impedance spectrum may introduce inaccuracies, as high impedance values result in only minor changes in the S11 spectrum, making them difficult to detect with the reader's limited resolution.

To assess the accuracy of the sensor value extraction algorithm under varying conditions, the study conducted a simulation-based evaluation. This simulation accounted for real-world factors such as device sampling resolution and data noise to mimic actual collected data. This approach was chosen due to the vast number of potential circuit configurations and conditions in a smart textile interface, making physical testing impractical. Simulations enabled us to gain a deeper understanding of the algorithm's performance across different scenarios (e.g., varying transmission line lengths and sensor values) and provided valuable insights for future system design, optimization, and implementation.

The first step in the sensor value estimation algorithm was calculating the coupling factor. This experiment aimed to assess the accuracy of the calculated coupling factor across different reference circuit configurations and transmission line lengths in a smart textile interface, providing insights for designing the reference circuit. To evaluate the performance of coupling factor estimation, the study developed a simulator to generate multiple S11 spectra simulating measurements from the reader on various circuit setups. Using these spectra, the study calculated coupling factors with the algorithm and compared them to ground-truth values to assess accuracy.

The simulator used Eq. 1 to Eq. 6, validated herein To simplify the process, the study assumed the smart textile interface only involved the reference circuit with an open-circuited transmission line, as other sensor circuits would be designed to avoid overlap with the reference circuit's spectrum.

The parameters Lᵣ, C_{SMA}, and Lᵣ were set to 0.6 pH, 10 pF, and 4.54 pH based on coil design studies. The coupling factor ranged from 0.25 to 0.29 (perfect and weak alignment) randomly. Transmission line lengths were varied across four ranges: <25 cm, 25-50 cm, 50-75 cm, and 75-100 cm. For each range, the simulator randomly selected a length and generated the corresponding Cₗᵢₙₑ, Lₗᵢₙₑ, and Rₗᵢₙₑ values according to the transmission line design results. The study simulated resonant frequencies of the reference circuit from 1 MHz to 30 MHz in 100 steps, fixing the inductance-to-capacitance ratio at 1, and calculated the specific capacitance and inductance values.

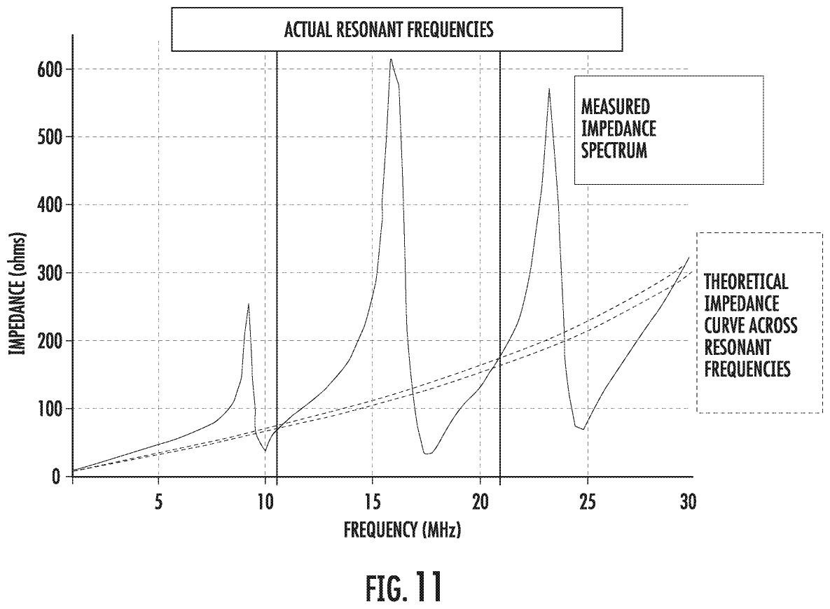

To simulate real-world conditions, the study limited the sampling resolution to 101 points across the spectrum and added Gaussian noise with three decimal places to each S11 value, reflecting the reader's resolution and precision. Each condition was repeated 1,000 times to account for randomness. In total, the simulator generated 4 transmission line length ranges×100 resonant frequencies×1,000 repetitions, producing 4,000,000 S11 spectra for analysis. For each spectrum, the study applied the first step of the algorithm to estimate the coupling factor, assessing accuracy by comparing the estimated value to the ground truth. 5.1.2 Results. The study averaged the accuracies across 1,000 repetitions and presented the results in FIG. 12A. The study found that transmission line length had no significant impact on accuracy, but the coupling factor estimation was less stable when the reference circuit's resonant frequency was below 10 MHz, ranging from 84% to 98%. This instability occurred because, at lower frequencies, the S11 values exhibited more pronounced changes when reactive components cancel out each other. If the sampling missed these changes, the interpolated spectrum became less accurate, leading to discrepancies in the coupling factor. Above 10 MHz, accuracy stabilized at about 99%. Optionally, the reference circuit's resonant frequency can be set above 10 MHz for accuracy and stability.

Next, the study validated the accuracy of sensor value estimation with a single sensor integrated into the smart textile interface. The study used a similar simulation approach to test accuracy under different sensor circuit configurations and varying transmission line lengths. Coil alignments were not tested, as previous experiments already demonstrated high accuracy in coupling factor estimation.

The study modified the simulator from the previous experiment to meet the objectives of this one. First, the study standardized the reference circuit design with a resonant frequency of 27 MHz and an inductance-to-capacitance ratio of 1. According to results from previous experiments, this configuration can provide accurate estimates of the coupling factor. Second, while the transmission line length was still randomly selected within the four defined ranges, the study introduced ±20% fluctuations in transmission line capacitance to simulate real-world conditions such as bending and folding. The example algorithm accounted for the initial capacitance, as the transmission line length is known during fabrication. The study kept the resistance and inductance of the transmission line stable, as previous studies showed these parameters did not vary significantly under different conditions. The study also added a sensor circuit, varying its resonant frequency from 1 MHz to 25 MHz in 100 steps and randomly assigning the inductance-to-capacitance ratio between 0.1 and 2. This setup allowed simulation of various sensor values. The study capped the resonant frequency at 25 MHz to avoid overlap with the reference circuit's frequency. The sensor circuit's resistance ranged from 10 ohms to 60 ohms, varying ±50% in each iteration to simulate changes in resistive sensor values. The other settings, including transmission line ranges and Gaussian noise, were the same as in the previous experiment.

In total, the simulator generated 4,000,000 S11 spectra (4 ranges×100 frequencies×1,000 repetitions). For each spectrum, the study first calculated the coupling factor and then estimated the sensor values. Since accuracy for capacitive and inductive sensor values is expected to be identical (Eq. 8), the study focused on capacitive sensor value estimation. Accuracy was determined by dividing the estimated sensor value by the set value. 5.2.2 Results. The study analyzed the accuracy of capacitive and resistive sensor value estimations separately, as they were addressed in different algorithm steps.

FIG. 12B shows the accuracy of capacitive sensor value estimation. Below 5 MHz, accuracy was unstable, similar to the coupling factor estimation. Above 5 MHz, accuracy stabilized at 99%. However, longer transmission lines reduced accuracy, particularly above 25 MHz, as longer lines increased capacitance, causing effects like short circuits. For transmission lines over 50 cm, accuracy dropped below 90% at high frequencies, emphasizing the importance of accounting for transmission line length when configuring sensor circuits.

For resistive sensor value estimation, FIG. 12C shows similar trends. Accuracy was low below 5 MHz but improved above 5 MHz. When transmission lines were under 25 cm, accuracy exceeded 90% from 5 MHz to 24 MHz, but dropped with longer lines. Experimenting with inductance-to-capacitance ratios, the study found that limiting the ratio to 0.5 improved accuracy, especially for longer transmission lines, e.g., from 84% to 93% in the 50-75 cm range. Lowering the ratio helped mitigate accuracy loss with longer lines, improving resistive sensor estimation performance.

Lastly, the study calculated transmission line capacitance estimation accuracy, which averaged 97% across configurations and line lengths. This indicates the algorithm's effectiveness in estimating capacitance, which could be useful to monitor line conditions such as bending or physical disturbances, enabling potential applications in activity sensing [77].

Estimating sensor values in the concurrent operation of multiple sensors posed additional challenges compared to a single sensor. For example, if the resonant frequencies of multiple sensor circuits were too close, interference could complicate estimation. The study evaluated the performance of the algorithm with three sensors embedded in the smart textile interface, using a similar simulation-based approach to assess the impact of different circuit configurations on the accuracy of multi-sensor value estimation.

The study used the same simulator as in the previous experiment, incorporating three sensor circuits into the smart textile interface. To assess how different configurations affect accuracy, the study varied the resonant frequency of one sensor circuit from 5 MHz to 20 MHz in 100 steps, adjusting the gap between its resonant frequency and those of the other two circuits. The frequency gap ranged from 1 MHz to 5 MHz in 1 MHz increments, with all sensor circuits constrained to a range between 1 MHz and 25 MHz. The inductance-to-capacitance ratio of each sensor circuit was randomly assigned between 0.1 and 2. The study limited the transmission line length to 0-25 cm, as longer lines were shown to reduce the available spectrum in the previous experiment. The modified simulator generated 500,000 S11 spectra for analysis (100 frequencies×5 gaps×1,000 repetitions). The study focused on estimating the sensor values of the circuit with the middle resonant frequency, as it was most affected by the neighboring circuits. The same algorithm was applied to estimate sensor values, allowing comparison with the single-sensor scenarios.

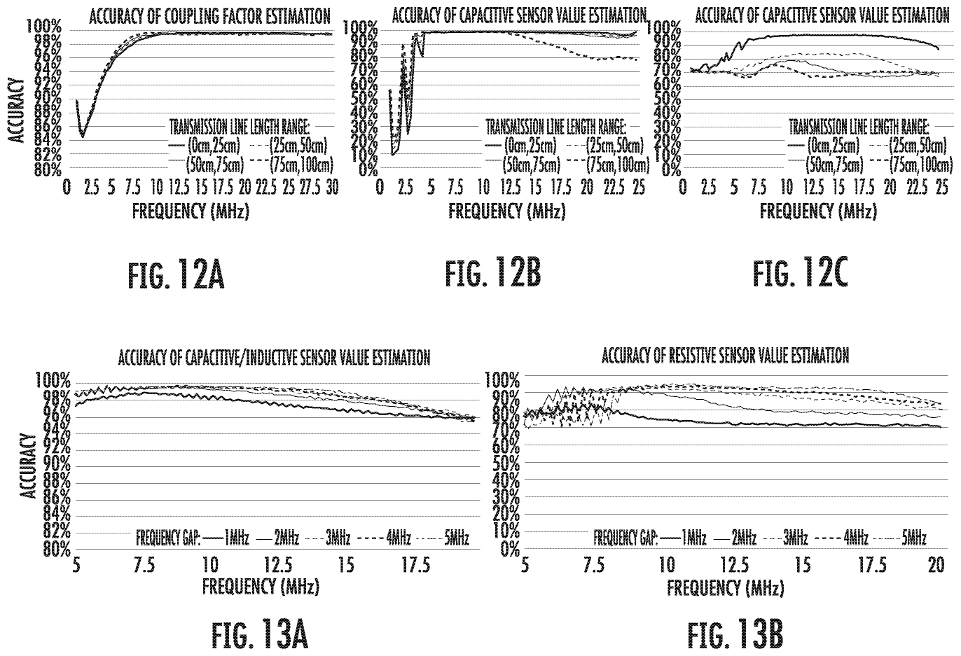

FIG. 13A shows the accuracy of capacitive sensor value estimation. As expected, smaller frequency gaps slightly reduced accuracy. For example, with a 1 MHz gap, accuracy averaged 97%, while a 5 MHz gap resulted in 98%, closely matching the single sensor scenario at 99%. The middle sensor circuit, influenced by both neighboring circuits, was the most challenging, but the other two circuits, with less interference, showed better accuracy. These results suggest the potential for expanding to more than three sensors in a smart textile interface. For instance, with a 2 MHz gap, up to 12 sensors could fit within the 1 MHz to 25 MHz range.

FIG. 13B shows resistive sensor value estimation accuracy. Below 10 MHz, accuracy was unstable due to difficulties estimating resonant frequency and transmission line capacitance, especially when one sensor circuit had a resonant frequency below 5 MHz. Above 10 MHz, accuracy stabilized. With a 1 MHz frequency gap, accuracy dropped to 74%, indicating increased interference. However, with a 5 MHz gap, accuracy rose to 88%, which is close to the 92% accuracy of the single-sensor scenario. This shows that the system can maintain high accuracy with multiple sensors if the frequency gap is sufficiently large.

To understand how the simulation study results deviate from real world performance, the study implemented a physical prototype and compared its accuracy in estimating the coupling factor (k), sensor capacitance (c), and resistance (r) with the simulated test results. The example implementation included a smart textile interface prototype using the selected coil and transmission line designs. The prototype included three sensor circuits with resonant frequencies of 9.9 MHz, 14.5 MHz, and 19.9 MHz, each connected to a 30 cm transmission line. To simulate changes in capacitive or resistive sensor values, the study prepared a set of fixed capacitors and resistors, enabling controlled adjustments to the resonant frequency of the middle-frequency sensor circuit from 12.2 MHz to 16.6 MHz and resistance from 10 to 50 ohms in five steps. The implemented a reader using a VNA and the chosen transmitter coil design. Aligning the reader's coil randomly with the interface's coil within 10 mm, the study measured the S11 spectrum from 5 MHz to 30 MHz with 101 data points. This setup was designed to mirror the simulation environment, ensuring consistency between simulated and physical test conditions.

To account for human body influence, the study recruited 10 participants (9 male, 1 female) and attached the prototype to their backs, similar to FIG. 6C. The study then randomly altered the coil alignment five times per participant, measuring the coupling factor using the standard approach [36] for each alignment. In addition, the study adjusted the capacitor and resistor in the middle-frequency sensor circuit to have five levels of capacitance and resistance. For each configuration, the study collected 20 S 11 spectra to account for possible impacts caused by body postures. In total, the study collected 3000 impedance spectra (10 people×(5 coupling factor+5 capacitance+5 resistance)×20 repetitions) to evaluate the accuracy of estimating the coupling factor, capacitance, and resistance. The average accuracies for estimating the coupling factor (k) and capacitance (c) were 98% and 96%, similar to the simulation results of 99% and 98% respectively. When converted to actual capacitance, the mean absolute error (MAE) of capacitance estimation was 0.45 pF. For resistance estimation, the average accuracy across all participants was 91%, ranging from 87% to 94%, with a mean absolute error of 2.2 ohms. These results aligned with the simulation outcomes (88% for the 5 MHz gap and 92% for single sensor estimation). The estimation of resistance exhibited a lower degree of accuracy in contrast to the capacitance estimation, potentially attributable to inaccuracies in the fitting process and the reader's limited resolution. Nevertheless, the accuracy levels for both resistance and capacitance estimation were sufficient for common textile sensors [13,53] to achieve activity detection, as the changes in sensor values exceeded the estimation error. This was further validated through the user study in Section 7. Overall, the result of the real-world experiments indicates that the simulation results closely matched the real-world performance of this prototype, validating the reliability of the model and the insights gained from the simulation study.

The example implementation included a “Battery-free, IC-less and Wireless Smart Textile Interface” which included a receiver coil, transmission lines, constant RLC components, and textile sensors, implemented on a Muslin Fabric Cotton substrate [5]. The study selected 34AWG Litz Wire [1], a common choice for low-resistance and insulated wiring [12, 22, 34] to fabricate the receiver coil and transmission lines. The study employed a Brother SE600 embroidery machine [9] to embroider the wire as bobbin thread through straight stitches with the stitch length of 2.5 mm. For constant RLC components, the study used 2-pin 0604 SMD components soldered onto the Litz wires, following the method described in [47]. Since SMD inductors typically have a low Q factor, the study replaced them with embroidered or I-shaped coil inductors when higher inductance was needed.

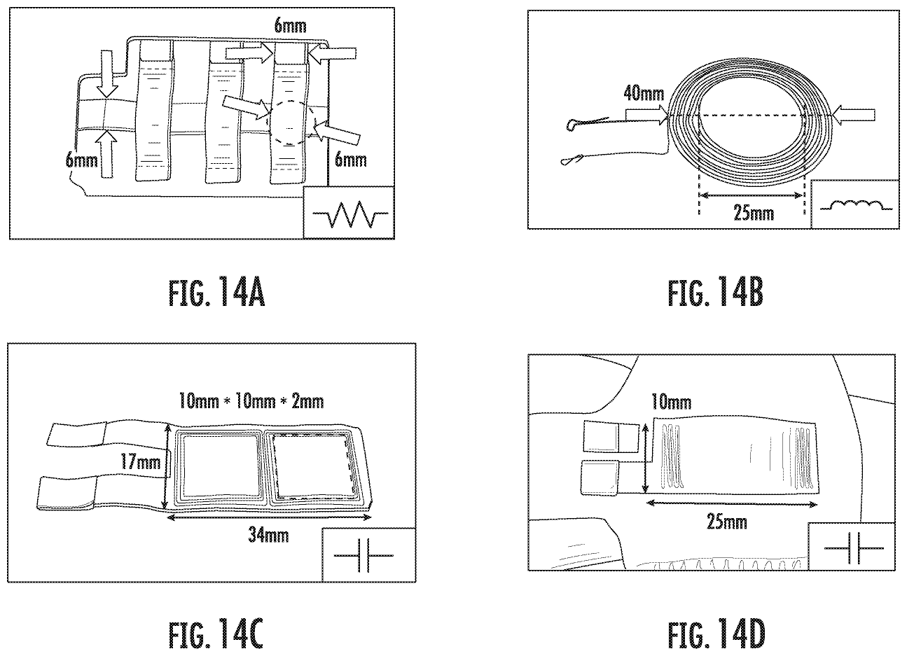

The example interface supports three types of sensors, including resistive, inductive, and capacitive sensors. To demonstrate its capabilities, the study implemented four representative sensors. Their dimensions and fabrication details are shown in FIG. 14A-14D, which illustrate an example resistive button, an example inductive object detector, an example capacitive pressure sensor, and an example capacitive bend sensor, respectively. Note that typical capacitive sensors operate on either self-capacitance or mutual capacitance principles [29]. Self-capacitance is the capacitance between an electrode and earth ground, while mutual capacitance occurs between two electrodes. The example system is incompatible with self-capacitance sensors due to the absence of a strong earth ground, resulting in minimal capacitance changes. In contrast, mutual capacitance sensors project capacitance changes effectively onto the resonant circuit, making them compatible with the system. Additionally, resistive sensors are commonly used in textile applications due to their robustness in varied environmental conditions, including wet environments where capacitive sensors may struggle.

The study implemented the reader as part of the system for capturing sensor data. This reader included a NanoVNA, connected to a transmitter coil measuring 10 mm by 10 mm, as shown in FIGS. 5A and 5B. Based on results of usable frequency range from section 5, the reader is designed to perform sweeps of frequencies ranging from 5 MHz to 30 MHz with a total of 101 sampling points. This entire operation is completed within 0.1 seconds, resulting in a sampling rate of 10 Hz for the system in its current state. While this sampling rate may not be considered high, it is sufficient for the requirements of a real-time interactive system. Higher sampling rate can be achieved by integrating dedicated frequency modulation chips and optimizing the signal processing pipeline. Once the reader captured the impedance data, it passes them to a laptop to process the signals. The example implementation used Trust Region Reflective least squares algorithm as the regression fit algorithm throughout the process.

The study considered example implementations of the present disclosure. Two usage scenarios to exemplify the capability of the example system. The demo applications were designed around everyday objects that frequently come into direct contact with mobile or wearable devices, including pockets and gloves. The study showcased how the example implementation approach can enable these everyday objects to become interactive, while still maintaining their passive nature and operating without the need for external hardware and batteries embedded in textile.

The study incorporated an inductive object detector, a capacitive pressure sensor, and a resistive button array into a battery-less and IC-less smart textile interface on a shirt (FIG. 5A). The inductive object sensor, in conjunction with an capacitor of 9.9 pF, operated within the frequency range from 20 M to 25 MHz. This sensor was strategically placed on a lower pocket of the shirt to detect metallic objects like keys. On the right shoulder of the shirt, the study integrated a capacitive pressure sensor that worked with a inductor of 6.5 pH. This sensor resonated within the frequency range from 10 M to 15 MHz and was designed to capture the pressure applied to the shoulder region, commonly caused by objects such as a shoulder bag. Additionally, the study included a button array sensor on the shirt sleeve. This sensor, in conjunction with an inductor of 23.9 pH and an capacitor of 19.1 pF, operated at the frequency around 7 MHz. The receiver coil was placed near the front pocket of the shirt, ready for the coupling from the reader.

The example shirt has several example applications, including health tracking, where a smartphone app monitors shoulder pressure and reminds the user to relieve it, preventing strain or pain. It can also detect metallic objects, like keys or access cards, in the pocket and trigger notifications if they're left behind. Additionally, the shirt features shortcut buttons on the sleeve for controlling music playback or interacting with an AI assistant.

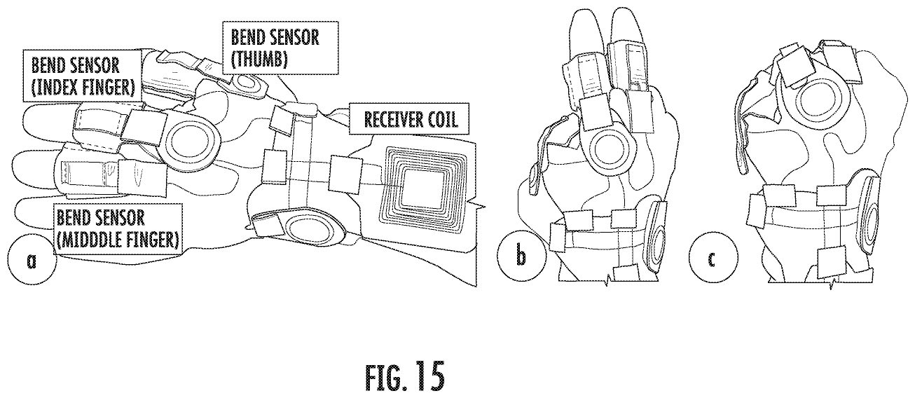

Although gloves are not typically used for storing personal devices, they share proximity with smartwatches on the user's wrist. With this in mind, the study integrated the smart textile interface into a glove, placing the receiver coil in a position that corresponds to where a smartwatch would typically be situated on the wrist as shown in FIG. 15. The example implementation incorporated three capacitive bending sensors on the glove to capture the gestures of thumb, index and middle fingers. Each bending sensor has been carefully paired with capacitors and inductors that possess the appropriate values, which allows each sensor to operate within designated frequency ranges.

The example glove can serve as an extension of the input device on the user's smartwatch, allowing users to control functions like answering calls with simple gestures such as peace and fist as shown in FIG. 15. Furthermore, the integration of the glove can enhance VR and AR experiences by empowering users to engage in immersive interactions without having to worry about charging the glove.

The study conducted an experiment to assess the effectiveness of the implementation of the interactive shirt prototype. The primary objective was to measure the accuracy of the approach in detecting various user inputs supported by this prototype.

10 participants were recruited for the study with a mix of 8 males and 2 females, and an average age of 23. All participants are righthanded to facilitate the operation of the sensor placed on the left arm using the dominant hand.

Prior to the study, participants were provided with a concise overview of the prototype. The participants had varying body shapes and typically wore clothing sizes ranging from small to large. During the study, they were instructed to wear the shirt and carry the hardware in the shirt's front pocket. Throughout the study, participants were given the freedom to adopt any posture they deemed comfortable. To evaluate the concurrent operation of the three sensors, the study asked participants to perform 60 tasks, with each task simultaneously testing all the three sensors. Specifically, each task consisted of: 1) carrying a shoulder bag to test the pressure sensor, 2) placing an object into a lower pocket to test the object detector, and 3) pressing a button on a sleeve to test the button array. For the bag carrying activity, participants carried either a 0.7 kg or 1.6 kg bag. For the object placement activity, participants placed either an apartment key or a plastic credit card into a pocket. For the button pressing activity, participants pressed one of the three buttons on the sleeve. This resulted in 12 unique combinations.

The study used the example algorithm to estimate sensor values for each S11 spectrum. Then, the study applied a decision tree classifier to categorize the estimated sensor signals. Due to the considerable variability in body characteristics among participants, the sensor values showed significant variation. Consequently, the analysis emphasized within-subject accuracy, using five-fold cross-validation to validate the classification performance.

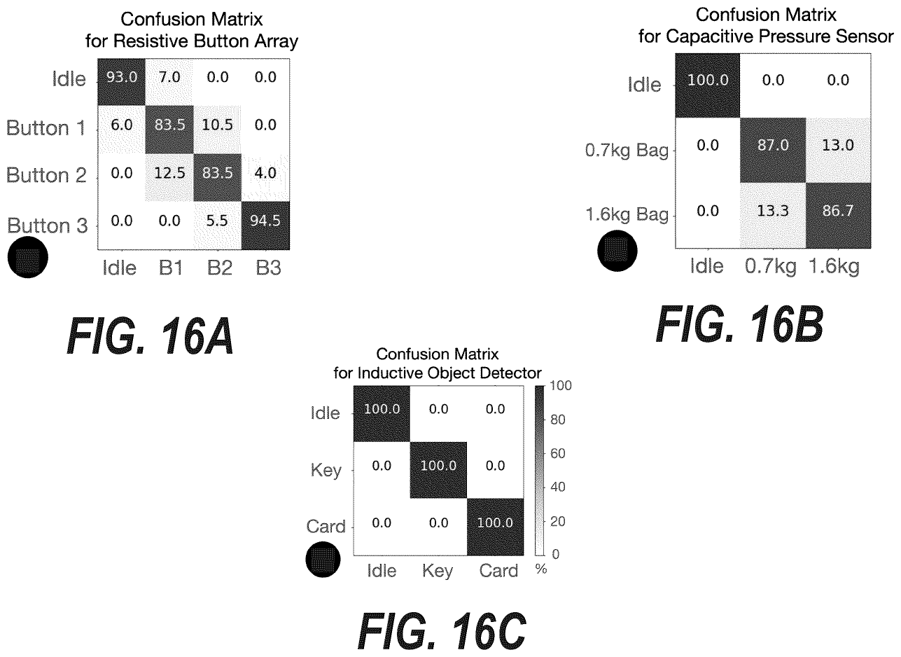

The results are shown in the confusion matrix in FIGS. 16A, 16B, and 16C. For the resistive button array, the average accuracy was 88%. The confusion matrix indicated significant overlap between the first and second buttons, likely due to participants applying varying levels of force across different trials. This variation may cause their resistance values to become similar. Grouping two buttons into the same category, the average accuracy can increase to 93%.

On the other hand, the capacitive pressure sensor demonstrated a higher average accuracy of 91%. The primary source of confusion was from the two tasks of carrying a shoulder bag with two different weights. This is likely because even the same participant might carry the bag differently, causing variations in pressure and sensor readings. Despite that, the estimated capacitive sensor values can still show acceptable accuracy for detecting this interaction with capacitance changes ranging from 3.0 pF to 6.0 pF across all the cases of carrying the bag (around 1.5 MHz of frequency change between cases).

Lastly, the inductive object detector achieved 100% accuracy. It demonstrated that the estimated inductive sensor values can reliably distinguish between two different objects and idle state with inductance changes of around 0.8 uH and 1.5 uH (around 2.5 MHz of frequency change between cases). Since the task was less influenced by participant behavior and the sensor robustly established a higher frequency change, the accuracy reached higher value compared with capacitance pressure sensor. This suggests that the system can reliably monitor user interactions given robust and well-designed sensors, without the incorporation of batteries and ICs into textiles.

In addition, the study also examined whether different combinations of tasks resulted in varying accuracy. As a result, no significant differences were observed.

Data accuracy, readout speed and power consumption of reader. The current implementation is limited in terms of accuracy and readout speed, making it less suitable for applications that require high-speed tracking of subtle sensor changes, such as strain sensors for detailed finger tracking. This limitation is primarily due to the measurement resolution and sampling rate of NanoVNA. However, a custom device integrated with dedicated frequency modulation chips [63] and a finely tuned measurement circuit can significantly mitigate this issue. Optimizing performance using the custom can include focused scanning of pertinent frequency ranges. For instance, concentrating impedance measurements solely on relevant resonant frequencies and update the entire spectrum at longer intervals. This approach can allow for enhanced resolution and quicker readings within the sensor's operational frequency range. Another solution is the multitone technique, where multiple frequencies are merged into a singular signal for concurrent impedance analysis. While this method promises faster readout speeds, there may be a potential trade-off in terms of measurement accuracy.

Additionally, power consumption was another consideration in the design of the reader. Implementations of the present disclosure can include readers with low-power components, optimizations to the measurement circuit [58], and/or employing power-efficient operating modes.

The example implementation was based on impedance modulation, which may reduce its compatibility with sensors based on voltage, such as microphones, EMG electrodes, and photodiodes. In some implementations of the present disclosure, a varicap, a compact two-pin component capable of converting voltage signals into variable capacitance, can be used in the sensor circuit. With varicaps, a wider range of sensors can be used.

Cross-textile interface. The coils on the open surfaces of a textile object are subject to movement and instability, making alignment challenging. In order to address this issue, different coil designs can be used, including larger or wider coils.

Implementations of the present disclosure further include methods for designing and implementing receiver coils, sensors, and transmission lines based on individual user interaction demands. For example, upon inputting desired sensor locations and types, a system like this could automatically generate an optimized design for coils, sensors, and transmission lines. Furthermore, this software tool can also enable the direct conversion of the optimized design into an embroidery file, allowing for the quick realization of the desired idea.

Pure-textile interface. The example implementation requires the inclusion of small, rigid components such as resistors, capacitors, and inductors within textiles. However, with advancements in material science research, it becomes possible to fabricate these rigid components entirely from textile-based materials. Consequently, future textile interfaces could potentially eliminate the need for any rigid components, relying solely on soft materials.

Hardware integration. The example system implementation relies on obtaining the impedance spectrum by measuring the S 11 values using a VNA. However, the example system can be integrated into smartphones and smartwatches, given that most personal computing devices already come equipped with built-in coils for wireless charging and NFC capabilities. This integration would enable the widespread adoption of smart textiles into everyday life.

Fabrication with Other Conductive Threads and Fabric Substrates. In the example implementation Muslin Fabric Cotton was used as the fabric substrate and 34AWG Litz Wire as the conductive wire for prototyping. However, other textile materials and conductive threads, such as polyester fabrics and silver-coated nylon, can also be used for smart textile interfaces according to the present disclosure.

The example implementation overcomes the challenges associated with incorporating rigid hardware components, such as integrated circuits (ICs), batteries, and connectors, into textile sensors. By leveraging nearfield electromagnetic coupling, BIT enables wireless power transfer and data acquisition from textile sensors without the need for traditional hardware embedded in textile. This approach improves usability, reduces manufacturing complexity, and minimizes the environmental impact of textile interfaces. A crucial aspect of the research is the development of a mathematical model and algorithm that take into consideration several challenges, including the influence of transmission lines and coil misalignment, allowing for accurate estimation of sensor readings. Through simulation-based and user-based experiments, the study demonstrated the feasibility and versatility of BIT. This research has the potential to transform the landscape of smart textiles, making them more accessible and seamlessly integrated into people's daily lives. By reducing reliance on rigid hardware components, the example approach paves the way for a future where smart textiles are not only comfortable to wear but also environmentally sustainable.

In the sensor value estimation algorithm, the study approximates the system impedance to Eq 6 when a sensor circuit is at its resonant frequency and has low resistance. Details of the equation's derivation and explain why the resonant frequencies of sensor circuits are not at the lowest peak in the impedance spectrum.

Based on the equivalent circuit model in Section 3.2, the reciprocal of the impedance of i^{th} sensor circuit (Zᵢ(f)) can be described as the following equation:

$$\frac{1}{{Z}_{i} ( f )} = \frac{1}{\frac{1}{\frac{1}{( 2 π {fl}_{i} - \frac{1}{2 π {fc}_{i}} ) j + {r}_{i}} + 2 π {fC}_{{line}_{i}} j} + 2 π {fL}_{{line}_{i}} j + {R}_{{line}_{i}}} \qquad ( 8 )$$

When the frequency (f) reaches the resonant frequency of k^{th} sensor circuit

$$( 2 π f = \frac{1}{\sqrt{{l}_{k} {c}_{k}}} ) ,$$

the reciprocal of Zᵢ(f)(i=k) becomes the following equation:

$$\frac{1}{{Z}_{k} ( f )} = \frac{1}{\frac{1}{2 π {fC}_{{line}_{k}} j + \frac{1}{{r}_{k}}} + 2 π {fL}_{{line}_{k}} j + {R}_{{line}_{k}}} \qquad ( 9 )$$

If the transmission lines' capacitance (Cₗᵢₙₑ_{ₖ}) is small enough, the capacitive reactance of the transmission lines becomes negligible compared to the resistance of the sensor circuit. In this case, the resistance of the sensor circuit (rₖ) dominates the overall impedance. The equation can then be approximated as:

$$\frac{1}{{Z}_{k} ( f )} = \frac{1}{\frac{1}{2 π {fC}_{{line}_{k}} j + \frac{1}{{r}_{k}}} + 2 π {fL}_{{line}_{k}} j + {R}_{{line}_{k}}} \approx \frac{1}{{r}_{k} + {R}_{{line}_{k}} + 2 π {fL}_{{line}_{k}} j} \qquad ( 10 )$$

Next, the study calculated the total impedance of the smart textile interface using Eq 3. The study added values of the reciprocal of impedance for all sensor circuits, denoted as

$${\sum }_{1}^{n} \frac{1}{{Z}_{i} ( f )} .$$

Given the assumption that resonant frequencies of each sensor circuit are separated with enough frequency gaps (or in other word, when one sensor circuit reaches its resonant point, the frequency is far away from other sensor circuit's resonant points), the study calculated

$${\sum }_{1}^{n} \frac{1}{{Z}_{i} ( f )}$$

at the resonant frequency of k^{th} sensor circuit as follows:

$${\sum }_{1}^{n} \frac{1}{{Z}_{i} ( f )} = \frac{1}{{r}_{k} + {R}_{{line}_{k}} + 2 π {fL}_{{line}_{k}} j} + {\sum }_{i \neq k} \frac{1}{{Z}_{i} ( f )} \qquad ( 11 )$$

As frequency (f) is away from the resonant frequency of i^{th}(i≠k) sensor circuit, the impedance of i^{th} sensor circuit is high enough and

$$\frac{1}{{Z}_{i} ( f )}$$

can be calculated as:

$$\frac{1}{{Z}_{i} ( f )} = \frac{1}{\frac{1}{2 π {fC}_{{line}_{i}} j} + 2 π {fL}_{{line}_{i}} j + {R}_{{line}_{i}}} ( i \neq k ) \qquad ( 12 )$$

When the transmission line is not too long, the frequency of the resonance formed by line capacitance Cₗᵢₙₑ_{ᵢ} and inductance (Lₗᵢₙₑ_{ᵢ}) is much higher than the resonant frequency of k^{th} sensor circuit (for example, 40 cm twisted transmission line owns a resonant frequency at 112 MHz) and Rₗᵢₙₑ_{ᵢ} is small, resulting a small value of

$$\frac{1}{{Z}_{i} ( f )}$$

within frequency range

$$\vert \frac{1}{{Z}_{i} ( f )} \vert \leq 0.004 when f \leq 30 MHz .$$

Then, assuming that the capacitive or inductive sensor circuit is with low resistance (e.g. rₖ+Rₗᵢₙₑ_{ₖ}≤15), the reciprocal of the impedance of k^{th} sensor circuit

$$( \frac{1}{{Z}_{k} ( f )} )$$

is much higher than the rest sensor circuits

$$( \vert \frac{1}{{Z}_{k} ( f )} \vert \geq 0. 041$$

when f≤30 MHz and line length=40 cm), making influence of other sensor circuits negligible.

Then, by combining Eq 1 to Eq 3 and the approximation result, the study can calculate Z(f) as:

$$Z ( f ) = \frac{1}{\frac{1}{( 2 π {fL}_{t} ) j - \frac{{( ( 2 π f ) k \sqrt{( {L}_{L} {L}_{r} ) j} )}^{2}}{{r}_{k} + {R}_{line k} + 2 π f ( {L}_{line}} j + {L}_{r} ) j} + 2 π {fC}_{SMA} j} \qquad ( 13 )$$

Subsequently, rᵢ and Rₗᵢₙₑ_{ₖ} can be neglected due to the dominance of transmission line and receiver coil's inductance. For example, at 7 MHz, the inductive impedance is approximately 200Ω without rᵢ and Rₗᵢₙₑ_{ₖ}, which is close to the absolute impedance (\sqrt{(200Ω)²+(15Ω)²}~200.5Ω) when the sum of rᵢ and Rₗᵢₙₑ_{ₖ} is 15Ω. Thus, the study can approximate the calculation of Z(f) (in terms of magnitude) by neglecting rₖ and Rₗᵢₙₑ_{ₖ}, finally gaining a result as follows:

$$\vert Z ( f ) \vert = \vert \frac{1}{\frac{1}{( 2 π {fL}_{t} ) j - \frac{{( ( 2 π f ) k \sqrt{( {L}_{t} {L}_{r} ) j} )}^{2}}{2 π f ( {L}_{line}^{i}} +} + 2 {L}_{r} ) j} + 2 π {fC}_{SMA} j \vert \qquad ( 14 )$$

Give this, higher resistance in the sensor circuit may reduce this approximation's accuracy, but its precision improves as frequency increases. Simulation results in Section 5 also support these findings.

Finally, Eq. 14 also explains why the impedance spectrum lowest peaks deviate from the resonant frequencies of sensor circuits. These deviations result from combined factors, including receiver coil inductance and transmission line's impedance. Additionally, if the resonant frequencies of the sensor circuits are too close to each other, their interactions can cause further shifts in the impedance spectrum.

### REFERENCES

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.
[1] 2023. BNTECHGO 34 AWG Magnet Wire—Enameled Copper Wire. https://a.co/d/8WXGLc8.
[2] 2023. Conductive Rubber. https://item.taobao.com/item.htm?_u=d208umq5sq61f9&id=593175778341&spm=alz09.2.0.0.54f02e8drZJAEL.
[3] 2023. DE-5000 Handheld LCR Meter. https://a.co/d/6Y5U01U.
[4] 2023. MFRC-522 Reader. http://e.tb.cn/h.gpG0cRza9YY6H4i?tk=2OP1364Smic.
[5] 2023. Muslin Fabric Cotton Cloth. https://a.co/d/1xYwx9R.
[6] 2024. Conductive Fabric. https://item.taobao.com/item.htm?id=526286030147.
[7] 2024. NanoVNA. https://nanorfe.com/nanovna-v2.html.
[8] 2024. Resistive Foam. https://item.taobao.com/item.htm?id=778700605731.
[9] 2024. SE600 Computerized Sewing and Embroidery Machine with 4″×4″ Embroidery Area. https://www.brother-usa.com/products/se600.
[10] 2024. SMA Connector. https://detail.tmall.com/item.htm?id=555269804122&ns=1&skuId=3427497713332.
[11] M. Ahsan, S. H. Teay, A. S. M. Sayem, and A. Albarbar. 2022. Smart Clothing Framework for Health Monitoring Applications. Signals 3, 1 (March 2022), 113-145. https://doi.org/10.3390/signals3010009
[12] Roland Aigner, Mira Alida Haberfellner, and Michael Haller. 2024. Loopsense: low-scale, unobtrusive, and minimally invasive knitted force sensors for multimodal input, enabled by selective loop-meshing. In Proceedings of the 2024 CHI Conference on Human Factors in Computing Systems (Honolulu, HI, USA) (CHI '24). Association for Computing Machinery, New York, NY, USA, Article 862, 17 pages. https://doi.org/10.1145/3613904.3642528
[13] Roland Aigner, Andreas Pointner, Thomas Preindl, Rainer Danner, and Michael Haller. 2021. TexYZ: Embroidering Enameled Wires for Three Degree-of Freedom Mutual Capacitive Sensing. In Proceedings of the 2021 CHI Conference on Human Factors in Computing Systems (Yokohama, Japan) (CHI '21). Association for Computing Machinery, New York, NY, USA, Article 499, 12 pages. https://doi.org/10.1145/3411764.3445479
[14] Roland Aigner, Andreas Pointner, Thomas Preindl, Patrick Parzer, and Michael Haller. 2020. Embroidered Resistive Pressure Sensors: A Novel Approach for Textile Interfaces. In Proceedings of the 2020 CHI Conference on Human Factors in Computing Systems (Honolulu, HI, USA) (CHI '20). Association for Computing Machinery, New York, NY, USA, 1-13. https://doi.org/10.1145/3313831.3376305
[15] Mary Ellen Berglund, Julia Duvall, Cory Simon, and Lucy E. Dunne. 2015. Surface mount component attachment for e-textiles. In Proceedings of the 2015 ACM International Symposium on Wearable Computers (Osaka, Japan) (ISWC '15). Association for Computing Machinery, New York, NY, USA, 65-66. https://doi.org/10.1145/2802083.2808413
[16] T. Blecha. [n. d.]. Printed and Embroidered Electronic Passive Components.
[17] L. Buechley and M. Eisenberg. 2008. The LilyPad Arduino: Toward Wearable Engineering for Everyone. IEEE Pervasive Computing 7, 2 (April 2008), 12-15. https://doi.org/10.1109/MPRV.2008.38
[18] Leah Buechley and Benjamin Mako Hill. 2010. LilyPad in the wild: how hardware's long tail is supporting new engineering and design communities. In Proceedings of the 8th ACM Conference on Designing Interactive Systems (Aarhus, Denmark) (DIS '10). Association for Computing Machinery, New York, NY, USA, 199-207. https://doi.org/10.1145/1858171.1858206
[19] S. Charkhabi, K. J. Jackson, A. M. Beierle, A. R. Carr, E. M. Zellner, and N. F. Reuel. 2021. Monitoring Wound Health through Bandages with Passive LC Resonant Sensors. ACS Sensors 6, 1 (January 2021), 111-122. https://doi.org/10.1021/acssensors. Oc01912
[20] A. Chen, J. Tan, X. Tao, P. Henry, and Z. Bai. 2019. Challenges in Knitted E-textiles. In Artificial Intelligence on Fashion and Textiles. 129-135.
[21] J. Cheng, O. Amft, G. Bahle, and P. Lukowicz. 2013. Designing Sensitive Wearable Capacitive Sensors for Activity Recognition. IEEE Sensors fournal 13, 10 (October 2013), 3935-3947. https://doi.org/10.1109/JSEN.2013.2259693
[22] Laura Devendorf and Chad Di Lauro. 2019. Adapting Double Weaving and Yarn Plying Techniques for Smart Textiles Applications. In Proceedings of the Thirteenth International Conference on Tangible, Embedded, and Embodied Interaction (Tempe, Arizona, USA) (TEI '19). Association for Computing Machinery, New York, NY, USA, 77-85. https://doi.org/10.1145/3294109.3295625
[23] V. Galli, S. K. Sailapu, T. J. Cuthbert, C. Ahmadizadeh, B. C. Hannigan, and C. Menon. 2023. Passive and Wireless All-Textile Wearable Sensor System. Advanced Science 10, 22 (August 2023), 2206665. https://doi.org/10.1002/advs. 202206665
[24] B. Gamier, P. Mariage, F. Rault, C. Cochrane, and V. Koncar. 2021. Electronic components less fully textile multiple resonant combiners for body-centric near field communication. Scientific Reports 11, 1 (January 2021), 2159. https://doi.org/10. 1038/s41598-021-81246-z
[25] B. Gamier, P. Mariage, F. Rault, C. Cochrane, and V. Koncar. 2023. Textile dual-band NFC-A4WP (13.56-6.78 MHz) combiner for wireless energy and data transmission for connected clothing. Scientific Reports 13, 1 (April 2023), 5613. https://doi.org/10.1038/s41598-023-31832-0
[26] Oliver Glauser, Daniele Panozzo, Otmar Hilliges, and Olga Sorkine-Hornung. 2019. Deformation Capture via Soft and Stretchable Sensor Arrays. ACM Trans. Graph. 38, 2, Article 16 (March 2019), 16 pages. https://doi.org/10.1145/3311972
[27] Jun Gong, Yu Wu, Lei Yan, Teddy Seyed, and Xing-Dong Yang. 2019. Tessutivo: Contextual Interactions on Interactive Fabrics with Inductive Sensing. In Proceedings of the 32nd Annual ACM Symposium on User Interface Software and Technology (New Orleans, LA, USA) (UIST '19). Association for Computing Machinery, New York, NY, USA, 29-41. https://doi.org/10.1145/3332165.3347897
[28] C. Grimes, C. Mungle, K. Zeng, M. Jain, W. Dreschel, M. Paulose, and K. Ong. 2002. Wireless Magnetoelastic Resonance Sensors: A Critical Review. Sensors 2, 7 (July 2002), 294-313. https://doi.org/10.3390/s20700294
[29] Tobias Grosse-Puppendahl, Christian Holz, Gabe Cohn, Raphael Wimmer, Oskar Bechtold, Steve Hodges, Matthew S. Reynolds, and Joshua R. Smith. 2017. Finding Common Ground: A Survey of Capacitive Sensing in Human-Computer Interaction. In Proceedings of the 2017 CHI Conference on Human Factors in Computing
Systems (Denver, Colorado, USA) (CHI '17). Association for Computing Machinery, New York, NY, USA, 3293-3315. https://doi.org/10.1145/3025453.3025808
[30] A. Hajiaghajani, A. H. Afandizadeh Zargari, M. Dautta, A. Jimenez, F. Kurdahi, and P. Tseng. 2021. Textile-integrated metamaterials for near-field multibody area networks. Nature Electronics 4, 11 (November 2021), 808-817. https://doi.org/10. 1038/s41928-021-00663-0
[31] Nur Al-huda Hamdan, Simon Voelker, and Jan Borchers. 2018. Sketch&Stitch: Interactive Embroidery for E-textiles. In Proceedings of the 2018 CHI Conference on Human Factors in Computing Systems (Montreal QC, Canada) (CHI '18). Association for Computing Machinery, New York, NY, USA, 1-13. https://doi.org/10.1145/3173574.3173656
[32] Florian Heller, Stefan Ivanov, Chat Wacharamanotham, and Jan Borchers. 2014. FabriTouch: exploring flexible touch input on textiles. In Proceedings of the 2014 ACM International Symposium on Wearable Computers (Seattle, Washington) (ISWC '14). Association for Computing Machinery, New York, NY, USA, 59-62. https://doi.org/10.1145/2634317.2634345
[33] Kunpeng Huang, Ruojia Sun, Ximeng Zhang, Md. Tahmidul Islam Molla, Margaret Dunne, Francois Guimbretiere, and Cindy Hsin-Liu Kao. 2021. WovenProbe: Probing Possibilities for Weaving Fully-Integrated On-Skin Systems Deployable in the Field. In Proceedings of the 2021 ACM Designing Interactive Systems Conference (Virtual Event, USA) (DIS '21). Association for Computing Machinery, New York, NY, USA, 1143-1158. https://doi.org/10.1145/3461778.3462105
[34] Theo Hughes-Riley, Arash M. Shahidi, Kalana Marasinghe, Zahra Rahemtulla, Malindu Ehelagasthenna, Parvin Ebrahimi, Richard Arm, Carlos Oliveira, Lars Erik Holmquist, and Tilak Dias. 2024. Wearable Electronic Textiles for Healthcare, Wellbeing, and Protective Applications. In Extended Abstracts of the CHI Conference on Human Factors in Computing Systems (Honolulu, HI, USA) (CHI EA '24). Association for Computing Machinery, New York, NY, USA, Article 426, 5 pages. https://doi.org/10.1145/3613905.3648646
[35] I. Ibanez-Labiano and A. Alomainy. 2020. Dielectric Characterization of NonConductive Fabrics for Temperature Sensing through Resonating Antenna Structures. Materials 13, 6 (March 2020), 1271. https://doi.org/10.3390/ma13061271
[36] S.-J. Jeon and D.-W. Seo. 2019. Coupling Coefficient Measurement Method with Simple Procedures Using a Two-Port Network Analyzer for a Multi-Coil WPT System. Energies 12, 20 (October 2019), 3950. https://doi.org/10.3390/en12203950
[37] Majeed Kazemitabaar, Jason McPeak, Alexander Jiao, Liang He, Thomas Outing, and Jon E. Froehlich. 2017. MakerWear: A Tangible Approach to Interactive Wearable Creation for Children. In Proceedings of the 2017 CHI Conference on Human Factors in Computing Systems (Denver, Colorado, USA) (CHI '17). Association for Computing Machinery, New York, NY, USA, 133-145. https://doi.org/10.1145/3025453.3025887
[38] Majeed Kazemitabaar, Leyla Norooz, Mona Leigh Guha, and Jon E. Froehlich. 2015. MakerShoe: towards a wearable e-textile construction kit to support creativity, playful making, and self-expression. In Proceedings of the 14th International Conference on Interaction Design and Children (Boston, Massachusetts) (IDC '15). Association for Computing Machinery, New York, NY, USA, 449-452. https://doi.org/10.1145/2771839.2771883
[39] Konstantin Klamka, Raimund Dachselt, and Jürgen Steimle. 2020. Rapid IronOn User Interfaces: Hands-on Fabrication of Interactive Textile Prototypes. In Proceedings of the 2020 CHI Conference on Human Factors in Computing Systems (Honolulu, HI, USA) (CHI '20). Association for Computing Machinery, New York, NY, USA, 1-14. https://doi.org/10.1145/3313831.3376220
[40] Pin-Sung Ku, Qijia Shao, Te-Yen Wu, Jun Gong, Ziyan Zhu, Xia Zhou, and XingDong Yang. 2020. ThreadSense: Locating Touch on an Extremely Thin Interactive Thread. In Proceedings of the 2020 CHI Conference on Human Factors in Computing Systems (Honolulu, HI, USA) (CHI '20). Association for Computing Machinery, New York, NY, USA, 1-12. https://doi.org/10.1145/3313831.3376779
[41] Josué Lara-Reyes, Mario Ponce-Silva, Leobardo Hernández-González, Susana E DeLeón-Aldaco, Claudia Cortés-García, and Jazmin Ramirez-Hernandez. 2022. Series RLC Resonant Circuit Used as Frequency Multiplier. Energies 15, 24 (2022), 9334.
[42] K. Lee, N. Chou, and S. Kim. 2018. A Batteryless, Wireless Strain Sensor Using Resonant Frequency Modulation. Sensors 18, 11 (November 2018), 3955. https://doi. org/10.3390/s18113955
[43] Y.-D. Lee and W.-Y. Chung. 2009. Wireless sensor network based wearable smart shirt for ubiquitous health and activity monitoring. Sensors and Actuators B: Chemical 140, 2 (July 2009), 390-395. https://doi.org/10.1016/j.snb.2009.04.040
[44] R. Lin, H.-J. Kim, S. Achavananthadith, S. A. Kurt, S. C. C. Tan, H. Yao, B. C. K. Tee, J. K. W. Lee, and J. S. Ho. 2020. Wireless battery-free body sensor networks using near-field-enabled clothing. Nature Communications 11, 1 (January 2020), 444. https://doi.org/10.1038/s41467-020-14311-2
[45] Ruibo Liu, Qijia Shao, Siqi Wang, Christina Ru, Devin Balkcom, and Xia Zhou. 2019. Reconstructing Human Joint Motion with Computational Fabrics. Proc. ACM Interact. Mob. Wearable Ubiquitous Technol. 3, 1, Article 19 (March 2019), 26 pages. https://doi.org/10.1145/3314406
[46] S. Majumder, T. Mondal, and M. J. Deen. 2017. Wearable Sensors for Remote Health Monitoring. Sensors 17, 1 (January 2017), 130. https://doi.org/10.3390/s17010130
[47] Md. Tahmidul Islam Molla, Steven Goodman, Nicholas Schleif, Mary Ellen Berglund, Cade Zacharias, Crystal Compton, and Lucy E. Dunne. 2017. Surface mount manufacturing for e-textile circuits. In Proceedings of the 2017 ACM International Symposium on Wearable Computers (Maui, Hawaii) (ISWC '17). Association for Computing Machinery, New York, NY, USA, 18-25. https://doi.org/10.1145/3123021.3123058
[48] Grace Ngai, Stephen C. F. Chan, Joey C. Y. Cheung, and Winnie W. Y. Lau. 2009. The TeeBoard: an education-friendly construction platform for e-textiles and wearable computing. In Proceedings of the SIGCHI Conference on Human Factors in Computing Systems (Boston, MA, USA) (CHI '09). Association for Computing Machinery, New York, NY, USA, 249-258. https://doi.org/10.1145/1518701.1518742
[49] Grace Ngai, Stephen C. F. Chan, Vincent T. Y. Ng, Joey C. Y. Cheung, Sam S. S. Choy, Winnie W. Y. Lau, and Jason T. P. Tse. 2010. i*CATch: a scalable plug-n-play wearable computing framework for novices and children. In Proceedings of the SIGCHI Conference on Human Factors in Computing Systems (Atlanta, Georgia, USA) (CHI '10). Association for Computing Machinery, New York, NY, USA, 443-452. https://doi.org/10.1145/1753326.1753393
[50] Alex Olwal, Jon Moeller, Greg Priest-Dorman, Thad Starner, and Ben Carroll. 2018. I/O Braid: Scalable Touch-Sensitive Lighted Cords Using Spiraling, Repeating Sensing Textiles and Fiber Optics. In Proceedings of the 31st Annual ACM Symposium on User Interface Software and Technology (Berlin, Germany) (UIST '18). Association for Computing Machinery, New York, NY, USA, 485-497. https://doi.org/10.1145/3242587.3242638
[51] Alex Olwal, Thad Starner, and Gowa Mainini. 2020. E-Textile Microinteractions: Augmenting Twist with Flick, Slide and Grasp Gestures for Soft Electronics. In Proceedings of the 2020 CHI Conference on Human Factors in Computing Systems (Honolulu, HI, USA) (CHI '20). Association for Computing Machinery, New York, NY, USA, 1-13. https://doi.org/10.1145/3313831.3376236
[52] S. H. W. Ossevoort. 2013. Improving the sustainability of smart textiles. Elsevier, 399-419.
[53] Patrick Parzer, Florian Perteneder, Kathrin Probst, Christian Rendl, Joanne Leong, Sarah Schuetz, Anita Vogl, Reinhard Schwoediauer, Martin Kaltenbrunner, Siegfried Bauer, and Michael Haller. 2018. RESi: A Highly Flexible, Pressure Sensitive, Imperceptible Textile Interface Based on Resistive Yarns. In Proceedings of the 31st Annual ACM Symposium on User Interface Software and Technology (Berlin, Germany) (UIST '18). Association for Computing Machinery, New York, NY, USA, 745-756. https://doi.org/10.1145/3242587.3242664
[54] Patrick Parzer, Adwait Sharma, Anita Vogl, Jürgen Steimle, Alex Olwal, and Michael Haller. 2017. SmartSleeve: Real-time Sensing of Surface and Deformation Gestures on Flexible, Interactive Textiles, using a Hybrid Gesture Detection Pipeline. In Proceedings of the 30th Annual ACM Symposium on User Interface Software and Technology (Québec City, QC, Canada) (UIST '17). Association for Computing Machinery, New York, NY, USA, 565-577. https://doi.org/10.1145/3126594.3126652
[55] E. R. Post, M. Orth, P. R. Russo, and N. Gershenfeld. 2000. E-broidery: design and fabrication of textile-based computing. IBM Systems fournal 39, 3-4 (July 2000), 840-860. https://doi.org/10.1147/sj. 393.0840
[56] Ivan Poupyrev, Nan-Wei Gong, Shiho Fukuhara, Mustafa Emre Karagozler, Carsten Schwesig, and Karen E. Robinson. 2016. Project Jacquard: Interactive Digital Textiles at Scale. In Proceedings of the 2016 CHI Conference on Hu man Factors in Computing Systems (San Jose, California, USA) (CHI '16). Association for Computing Machinery, New York, NY, USA, 4216-4227. https://doi.org/10.1145/2858036.2858176
[57] J. Riistama, E. Aittokallio, J. Verho, and J. Lekkala. 2010. Totally passive wireless biopotential measurement sensor by utilizing inductively coupled resonance circuits. Sensors and Actuators A: Physical 157, 2 (February 2010), 313-321. https://doi.org/10.1016/j.sna.2009.11.038
[58] Jordi Sacristian-Riquelme, Fredy Segura-Quijano, Antoni Baldi, and M. Teresa Osés. 2009. Low power impedance measurement integrated circuit for sensor applications. Microelectronics Journal 40, 1 (2009), 177-184. https://doi.org/10. 1016/j.mejo.2008.07.003
[59] C. Saha, I. Anya, C. Alexandru, and R. Jinks. 2018. Wireless power transfer using relay resonators. Applied Physics Letters 112, 26 (June 2018), 263902. https://doi.org/10.1063/1.5022032
[60] T. Salpavaara. 2018. Inductively Coupled Passive Resonance Sensors: Readout Methods and Applications. Ph. D. Dissertation. Tampere University of Technology.
[61] D.-W. Seo, J.-H. Lee, and H. Lee. 2016. A Study on Two-coil and Four-coil Wireless Power Transfer System Using Z-parameter Approach. ETRI fournal (February 2016). https://doi.org/10.4218/etrij.16.0115.0692
[62] Teddy Seyed, James Devine, Joe Finney, Michal Moskal, Peli de Halleux, Steve Hodges, Thomas Ball, and Asta Roseway. 2021. Rethinking the Runway: Using Avant-Garde Fashion To Design a System for Wearables. In Proceedings of the 2021 CHI Conference on Human Factors in Computing Systems (Yokohama, Japan) (CHI '21). Association for Computing Machinery, New York, NY, USA, Article 45, 15 pages. https://doi.org/10.1145/3411764.3445643
[63] X. Sun, H. Wu, X. Tan, W. Wang, L. Ye, and K. Song. 2022. Frequency-Modulated Signal Measurement Using Closed-Loop Methodology. Sensors 22, 20 (October 2022), 7822. https://doi.org/10.3390/s22207822
[64] Z. Sun, H. Fang, B. Xu, L. Yang, H. Niu, H. Wang, D. Chen, Y. Liu, Z. Wang, Y. Wang, and Q. Guo. 2021. Flexible Wireless Passive LC Pressure Sensor with Design Methodology and Cost-Effective Preparation. Micromachines 12, 8 (August 2021), 976. https://doi.org/10.3390/mi12080976
[65] T. Tat, G. Chen, X. Zhao, Y. Zhou, J. Xu, and J. Chen. 2022. Smart Textiles for Healthcare and Sustainability. ACS Nano 16, 9 (September 2022), 13301-13313. https://doi.org/10.1021/acsnano.2c06287
[66] M. Timmins. 2009. Environmental and waste issues concerning the production of smart clothes and wearable technology. Woodhead Publishing, 319-331.
[67] Anita Vogl, Patrick Parzer, Teo Babic, Joanne Leong, Alex Olwal, and Michael Haller. 2017. StretchEBand: Enabling Fabric-based Interactions through Rapid Fabrication of Textile Stretch Sensors. In Proceedings of the 2017 CHI Conference on Human Factors in Computing Systems (Denver, Colorado, USA) (CHI '17). Association for Computing Machinery, New York, NY, USA, 2617-2627. https://doi.org/10.1145/3025453.3025938
[68] M. Wagih, A. Komolafe, and B. Zaghari. 2020. Dual-Receiver Wearable 6.78 MHz Resonant Inductive Wireless Power Transfer Glove Using Embroidered Textile Coils. IEEE Access 8 (2020), 24630-24642.
[69] Yuntao Wang, Jianyu Zhou, Hanchuan Li, Tengxiang Zhang, Minxuan Gao, Zhuolin Cheng, Chun Yu, Shwetak Patel, and Yuanchun Shi. 2019. FlexTouch: Enabling Large-Scale Interaction Sensing Beyond Touchscreens Using Flexible and Conductive Materials. Proc. ACM Interact. Mob. Wearable Ubiquitous Technol. 3, 3, Article 109 (September 2019), 20 pages. https://doi.org/10.1145/3351267
[70] Z. L. Wang. 2013. Triboelectric Nanogenerators as New Energy Technology for Self-Powered Systems and as Active Mechanical and Chemical Sensors. ACS Nano 7, 11 (November 2013), 9533-9557. https://doi.org/10.1021/nn404614z
[71] Te-Yen Wu, Shutong Qi, Junchi Chen, MuJie Shang, Jun Gong, Teddy Seyed, and Xing-Dong Yang. 2020. Fabriccio: Touchless Gestural Input on Interactive Fabrics. In Proceedings of the 2020 CHI Conference on Human Factors in Computing Systems (Honolulu, HI, USA) (CHI '20). Association for Computing Machinery, New York, NY, USA, 1-14. https://doi.org/10.1145/3313831.3376681
[72] Te-Yen Wu, Lu Tan, Yuji Zhang, Teddy Seyed, and Xing-Dong Yang. 2020. Capacitivo: Contact-Based Object Recognition on Interactive Fabrics using Capacitive Sensing. In Proceedings of the 33rd Annual ACM Symposium on User Interface Soft ware and Technology (Virtual Event, USA) (UIST '20). Association for Computing Machinery, New York, NY, USA, 649-661. https://doi.org/10.1145/3379337. 3415829
[73] Te-Yen Wu, Zheer Xu, Xing-Dong Yang, Steve Hodges, and Teddy Seyed. 2021. Project Tasca: Enabling Touch and Contextual Interactions with a Pocket-based Textile Sensor. In Proceedings of the 2021 CHI Conference on Human Factors in Computing Systems (Yokohama, Japan) (CHI '21). Association for Computing Machinery, New York, NY, USA, Article 4, 13 pages. https://doi.org/10.1145/3411764.3445712
[74] W. Xu, M.-C. Huang, N. Amini, L. He, and M. Sarrafzadeh. 2013. eCushion: A Textile Pressure Sensor Array Design and Calibration for Sitting Posture Analysis. IEEE Sensors fournal 13, 10 (October 2013), 3926-3934. https://doi.org/10.1109/JSEN. 2013.2259589
[75] Weifeng Yang, Shaomei Lin, Wei Gong, Rongzhou Lin, Chengmei Jiang, Xin Yang, Yunhao Hu, Jingjie Wang, Xiao Xiao, Kerui Li, Yaogang Li, Qinghong Zhang, John S. Ho, Yuxin Liu, Chengyi Hou, and Hongzhi Wang. 2024. Single body-coupled fiber enables chipless textile electronics. Science 384, 6691 (2024), 74-81. https://doi.org/10.1126/science.adk3755 arXiv:https://www.science.org/doi/pdf/10.1126/science.adk3755
[76] Huizhong Ye, Chi-Jung Lee, Te-Yen Wu, Xing-Dong Yang, Bing-Yu Chen, and Rong-Hao Liang. 2022. Body-Centric NFC: Body-Centric Interaction with NFC Devices Through Near-Field Enabled Clothing. In Proceedings of the 2022 ACM Designing Interactive Systems Conference (Virtual Event, Australia) (DIS '22). Association for Computing Machinery, New York, NY, USA, 1626-1639. https://doi.org/10.1145/3532106.3534569
[77] Tianhong Catherine Yu, Manru Mary Zhang, Peter He, Chi-Jung Lee, Cassidy Cheesman, Saif Mahmud, Ruidong Zhang, Francois Guimbretiere, and Cheng Zhang. 2024. SeamPose: Repurposing Seams as Capacitive Sensors in a Shirt for Upper-Body Pose Tracking. In Proceedings of the 37th Annual ACM Symposium on User Interface Software and Technology (Pittsburgh, PA, USA) (UIST '24). Association for Computing Machinery, New York, NY, USA, Article 72, 13 pages. https://doi.org/10.1145/3654777.3676341
[78] D. Zhu, L. Clare, B. H. Stark, and S. P. Beeby. 2015. Near field wireless power transfer using curved relay resonators for extended transfer distance. fournal of Physics: Conference Series 660 (December 2015), 012136. https://doi.org/10.1088/17426596/660/1/012136
[79] Jingwen Zhu and Hsin-Liu (Cindy) Kao. 2022. Scaling E-Textile Production: Understanding the Challenges of Soft Wearable Production for Individual Creators. In Proceedings of the 2022 ACM International Symposium on Wearable Computers (Cambridge, United Kingdom) (ISWC '22). Association for Computing Machinery, New York, NY, USA, 94-99. https://doi.org/10.1145/3544794.3558475

What is claimed:

1. A system comprising:
a woven smart textile substrate;
a receiver coil embroidered into the woven smart textile substrate;
a plurality of RLC circuits formed on the woven smart textile substrate, wherein the plurality of RLC circuits are coupled in parallel with the receiver coil, and wherein each of the RLC circuits comprises a resistor, capacitor and inductor, and wherein at least one of the resistor, capacitor, or inductor are configured as sensors; and a transmitter coil configured to read the plurality of RLC circuits.

2. The system of claim 1, wherein the plurality of RLC circuits are coupled by an embroidered transmission line formed on the smart textile substrate.

3. The system of claim 2, wherein the embroidered transmission line comprises a twisted transmission line.

4. The system of claim 3, wherein the plurality of RLC circuits each have a respective resonant frequency, and wherein the respective resonant frequencies of the RLC circuits are different from one another.

5. The system of claim 4, further comprising a plurality of sensors, wherein each of the plurality of RLC circuits are connected to at least one sensor of the plurality of sensors.

6. The system of claim 1, wherein the sensor comprises a strain sensor.

7. The system of claim 1, wherein the sensor comprises at least one of a resistive sensor, capacitive sensor, or inductive sensor.

8. A system comprising:
a woven smart textile substrate;
a receiver coil embroidered into the woven smart textile substrate;
a plurality of RLC circuits formed on the woven smart textile substrate, wherein the plurality of RLC circuits are coupled in parallel with the receiver coil, and wherein each of the RLC circuits comprises a resistor, capacitor and inductor, and wherein at least one of the resistor, capacitor, or inductor are configured as a sensor;
a transmitter coil configured to read the plurality of RLC circuits by the receiver coil;
a controller operably coupled to the transmitter coil, wherein the controller comprises a processor, and a memory comprising computer-readable instructions stored thereon, that, when executed by the processor, cause the processor to:
transmit, by the transmitter coil, a plurality of frequencies; and
receive, by the transmitter coil, a sensor for each sensor of each RLC circuit.

9. The system of claim 8, wherein the plurality of RLC circuits are coupled by an embroidered transmission line formed on the smart textile substrate.

10. The system of claim 9, wherein the embroidered transmission line comprises a twisted transmission line.

11. The system of claim 10, wherein the plurality of RLC circuits each have a respective resonant frequency, and wherein the respective resonant frequencies of the RLC circuits are different from one another.

12. The system of claim 11, further comprising a plurality of sensors, wherein each of the plurality of RLC circuits are coupled to at least one sensor of the plurality of sensors.

13. The system of claim 8, wherein the sensor comprises a strain sensor.

14. The system of claim 8, wherein the sensor comprises at least one of a resistive sensor, capacitive sensor, or inductive sensor.

15. A method of textile sensing, the method comprising:
energizing a textile interface using a handheld reader, wherein the textile interface comprises a plurality of sensors and a plurality of RLC circuits, wherein each of the plurality of RLC circuits are connected to at least one sensor of the plurality of sensors;
receiving a reflection from the textile interface at the handheld reader;
measuring the reflection from the textile interface; and
determining, based on the reflection, a sensor value for each RLC circuit.

16. The method of claim 15, wherein the textile interface comprises a sensor, a resonator circuit; operably coupled to the sensor, and a receiver coil operably coupled to the resonator circuit.

17. The method of claim 15, wherein determining the sensor value comprises estimating an impedance of the textile interface.

18. The method of claim 15, wherein determining the sensor value comprises estimating a reflection coefficient of the textile interface.

19. The method of claim 18, wherein the plurality of RLC circuits each have a respective resonant frequency, and wherein the handheld reader is configured to transmit each respective resonant frequency of the plurality of RLC circuits to read each sensor of the plurality of sensors.

20. The method of claim 15, wherein the sensor values comprise at least one detection of a button press.
